(19) United States
(12) Patent Application Publication
(10) Pub. No.: US 2022/0062896 A1
(43) Pub. Date: Mar. 3, 2022

(54) DEVICE COMPRISING AN OPTOFLUIDIC SENSOR WITH INTEGRATED PHOTODIODE

(71) Applicant: GLOBALFOUNDRIES U.S. Inc., Santa Clara, CA (US)

(72) Inventors: Steven M. Shank, Jericho, VT (US); Vibhor Jain, Essex Junction, VT (US); Anthony Stamper, Burlington, VT (US); John Pekarik, Underhill, VT (US); John Ellis-Monaghan, Grand Isle, VT (US); Ramsey Hazbun, Colchester, VT (US)

(21) Appl. No.: 17/006,050

(22) Filed: Aug. 28, 2020

(51) Int. Cl. B01L 3/00; G01N 21/05; G01N 21/85

(52) U.S. Cl. CPC B01L 3/502715; G01N 21/05; G01N 2201/067; B01L 2300/0627; G01N 21/85

(57) ABSTRACT

One illustrative device disclosed herein includes a semiconductor substrate, a channel that is at least partially defined by at least a portion of the semiconductor substrate, an input fluid reservoir and an output fluid reservoir, wherein the channel is in fluid communication with the input fluid reservoir and the output fluid reservoir. In this example, the device further includes a first radiation source operatively coupled to the substrate, wherein the first radiation source is adapted to generate radiation in a direction toward the channel, and at least one photodiode positioned adjacent the channel.

### FIELD OF THE INVENTION

The present disclosure generally relates to various novel embodiments of a device comprising an optofluidic sensor with integrated photodiode and various novel methods of making such a device.

### BACKGROUND

Optofluidics is a technology area that generally involves the use of microfluidic technology and optics technology. There are various applications or products where optofluidic technology may be employed, e.g., displays, biosensors, lab-on-chip devices, lenses, and molecular imaging tools and energy. However, such optofluidic devices are typically very expensive to manufacture, involve complex methods to package together discrete devices, and result in relatively large devices that are not readily scaled and such problems need to be addressed for the technology to advance.

### SUMMARY

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

The present disclosure is directed to various novel embodiments of a device comprising an optofluidic sensor with integrated photodiode and various novel methods of making such a device. One illustrative device disclosed herein includes a semiconductor substrate, a channel that is at least partially defined by at least a portion of the semiconductor substrate, an input fluid reservoir and an output fluid reservoir, wherein the channel is in fluid communication with the input fluid reservoir and the output fluid reservoir. In this example, the device further includes a first radiation source operatively coupled to the substrate, wherein the first radiation source is adapted to generate radiation in a direction toward the channel, and at least one photodiode positioned adjacent the channel.

### BRIEF DESCRIPTION OF THE DRAWINGS

The disclosure may be understood by reference to the following description taken in conjunction with the accompanying drawings, in which like reference numerals identify like elements, and in which:

FIGS. 1-38 depict various novel embodiments of an optofluidic sensor with integrated photodiode and various novel methods of making such a device. The drawings are not to scale.

While the subject matter disclosed herein is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

Various illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

The present subject matter will now be described with reference to the attached figures. Various structures, systems and devices are schematically depicted in the drawings for purposes of explanation only and so as to not obscure the present disclosure with details that are well known to those skilled in the art. Nevertheless, the attached drawings are included to describe and explain illustrative examples of the present disclosure. The words and phrases used herein should be understood and interpreted to have a meaning consistent with the under-standing of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase. As will be readily apparent to those skilled in the art upon a complete reading of the present application, the presently disclosed method may be applicable to a variety of products, including, but not limited to, logic products, memory products, etc. With reference to the attached figures, various illustrative embodiments of the methods and devices disclosed herein will now be described in more detail. The various components, structures and layers of material depicted herein may be formed using a variety of different materials and by performing a variety of known process operations, e.g., chemical vapor deposition (CVD), atomic layer deposition (ALD), a thermal growth process, spin-coating techniques, masking, etching, etc. The thicknesses of these various layers of material may also vary depending upon the particular application.

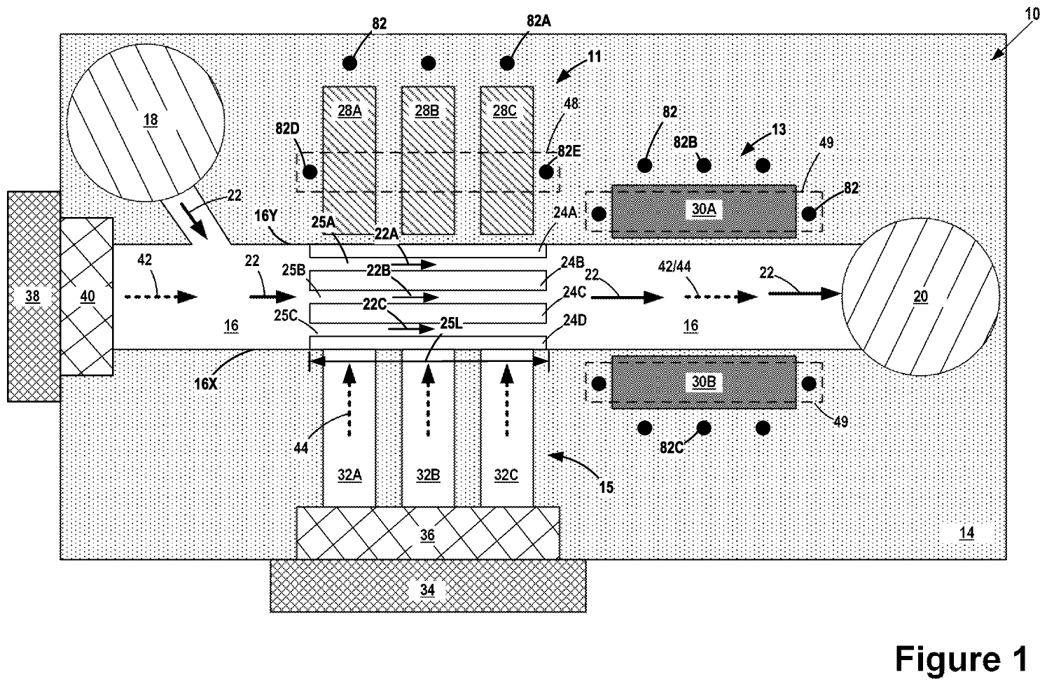

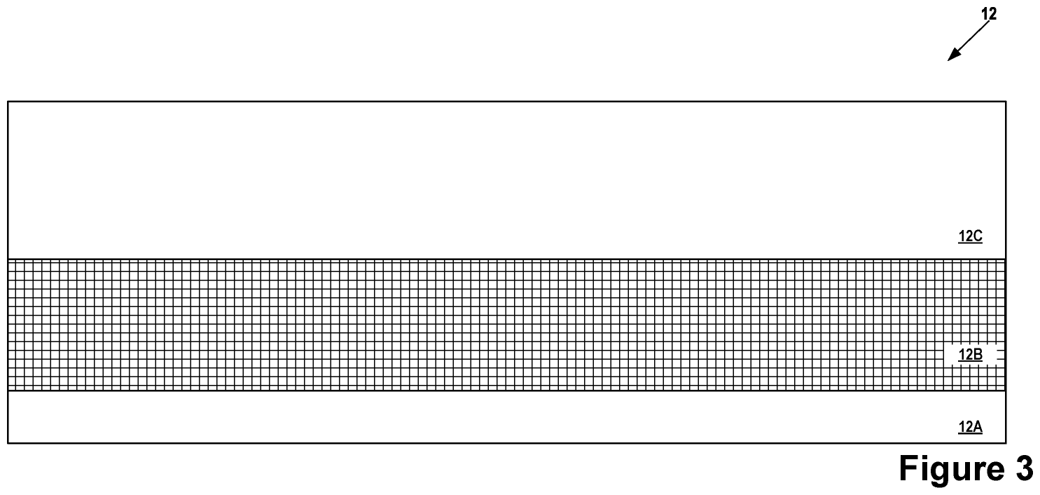

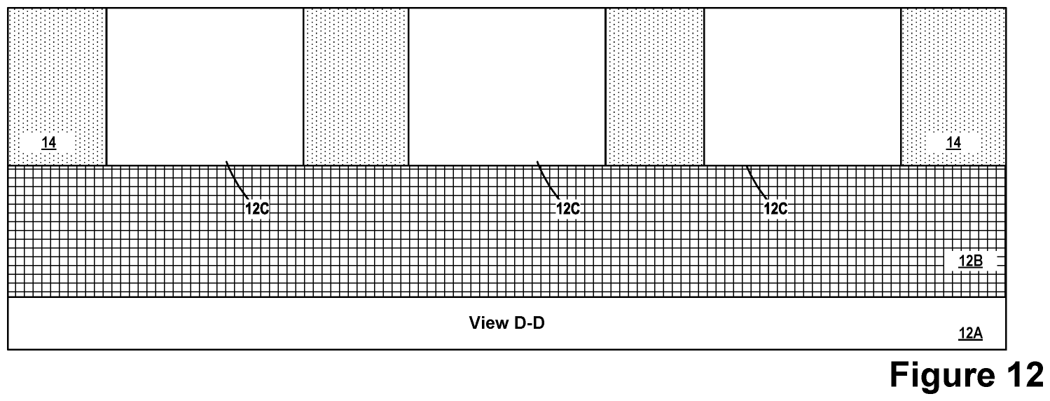

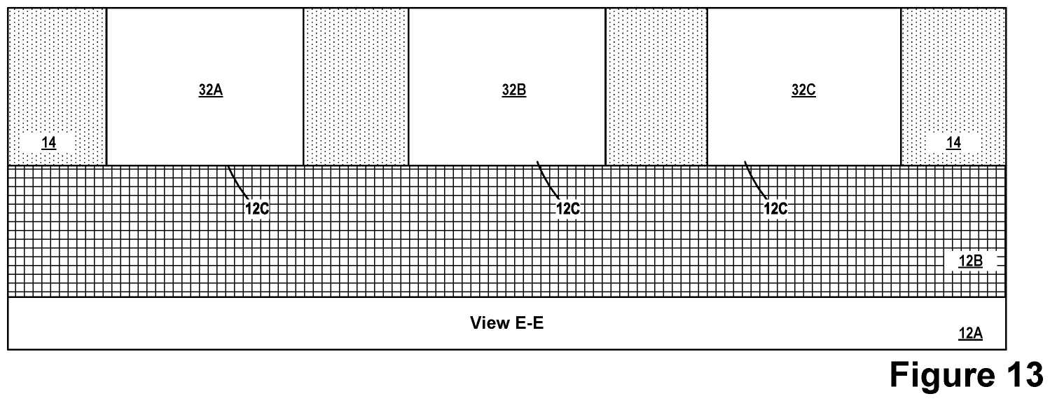

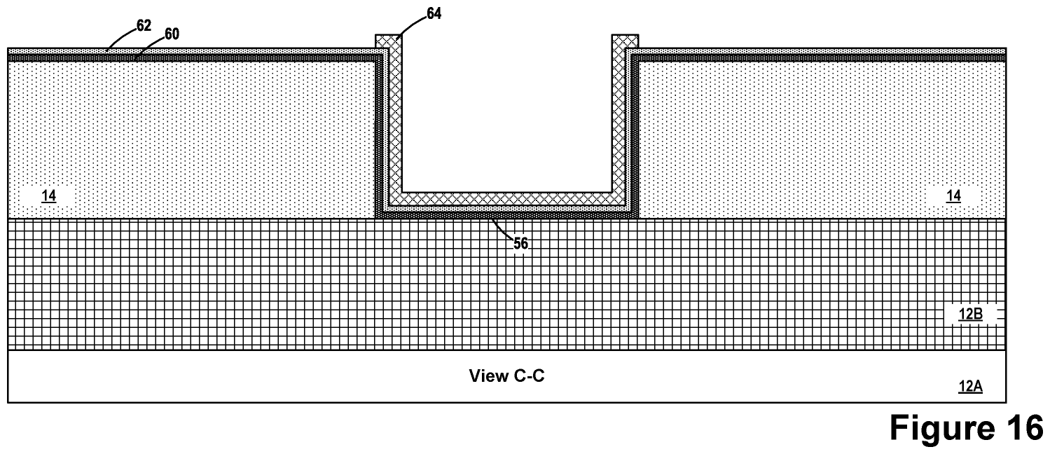

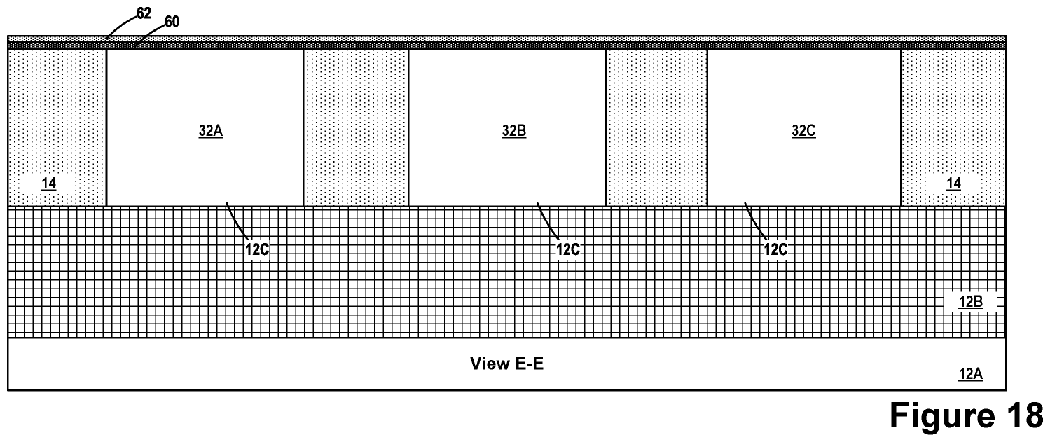

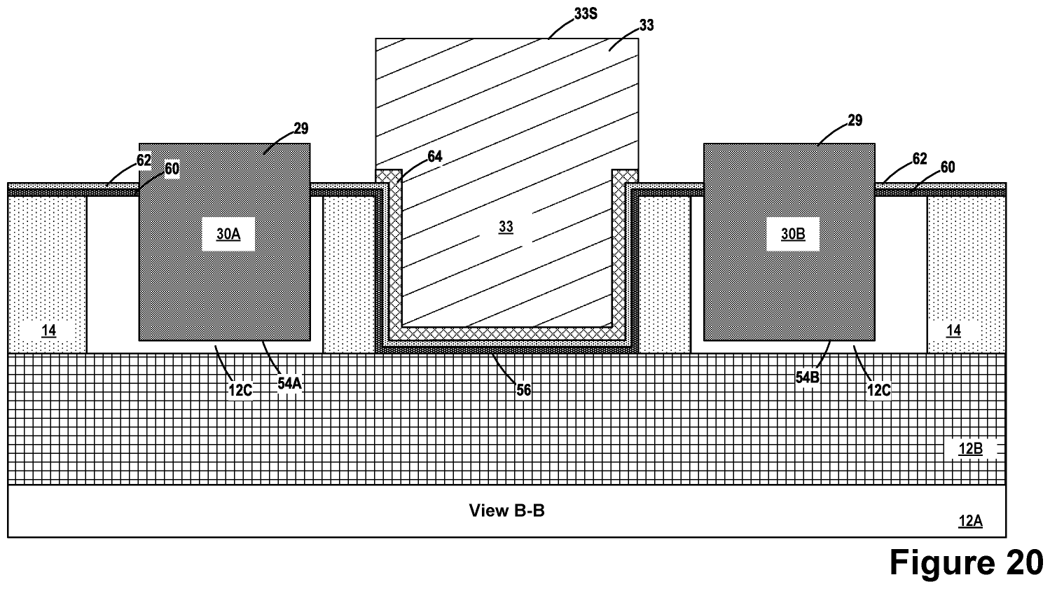

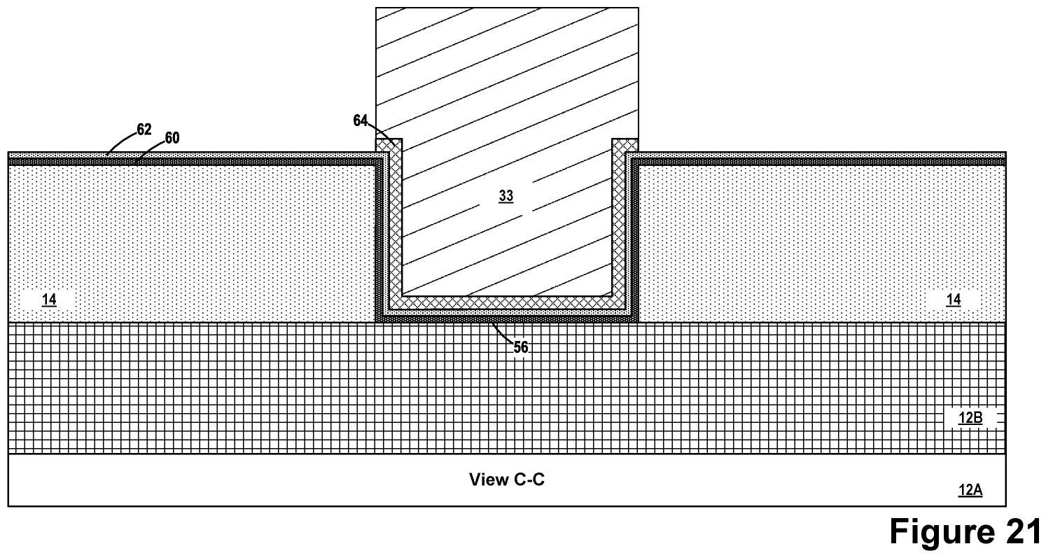

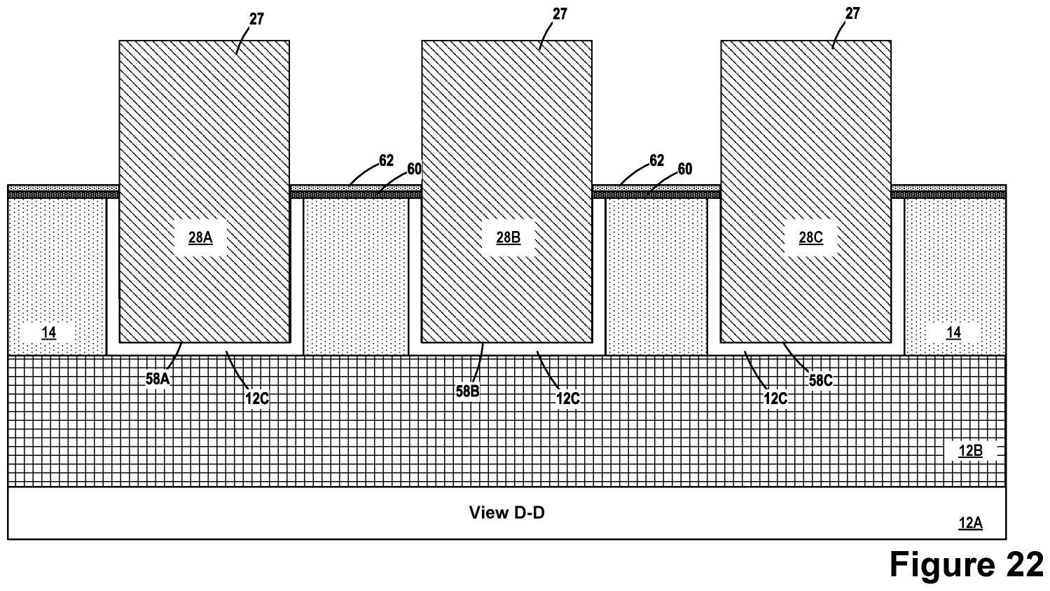

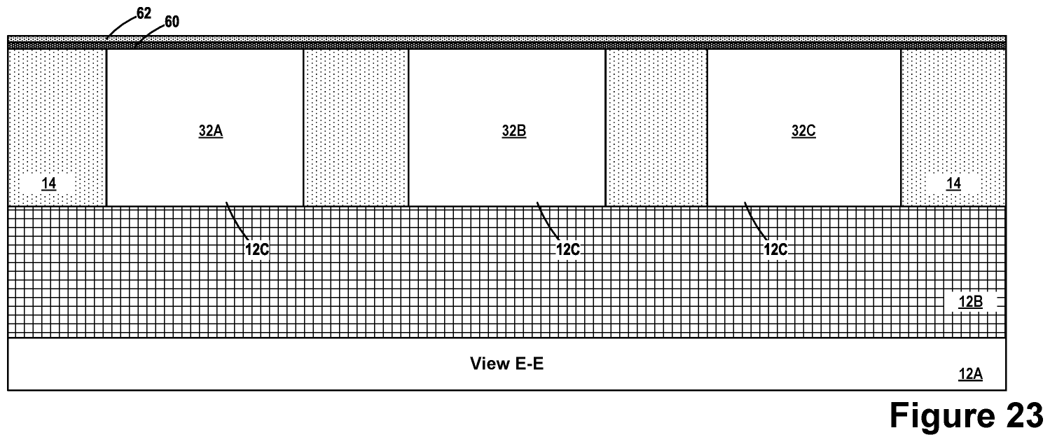

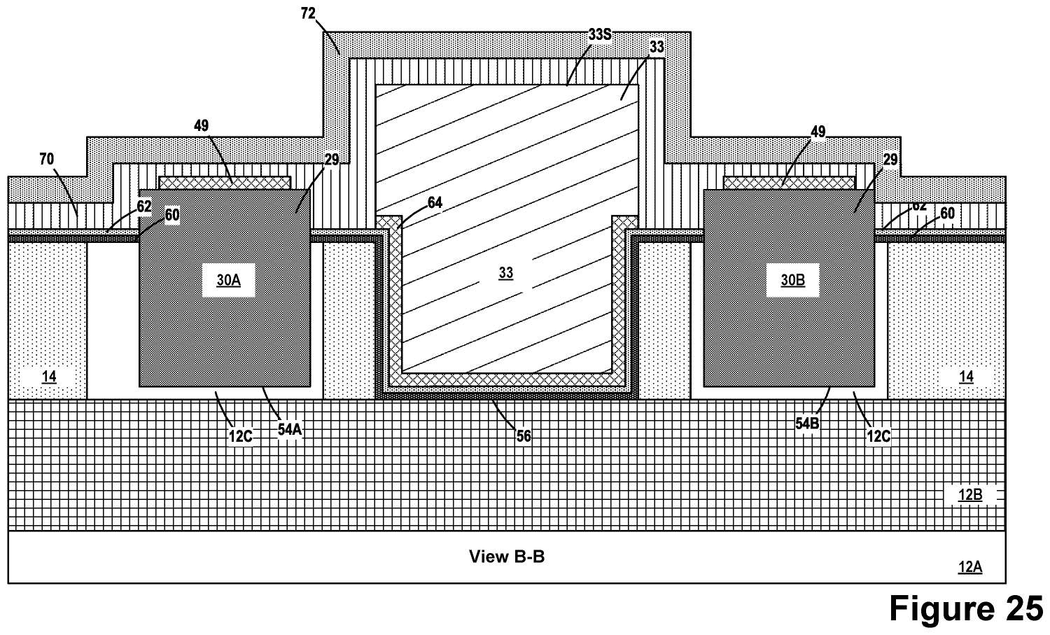

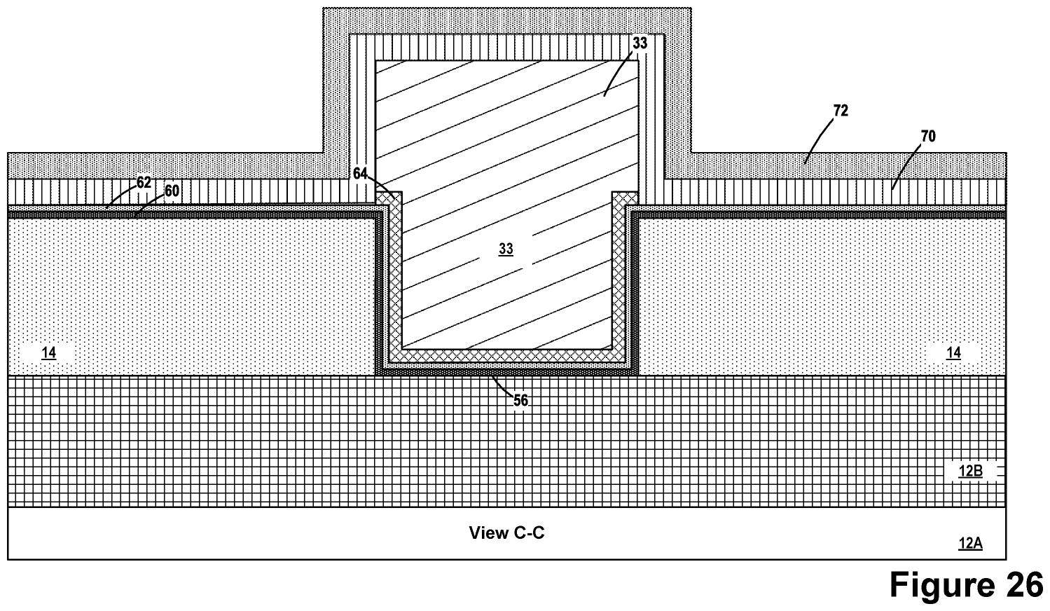

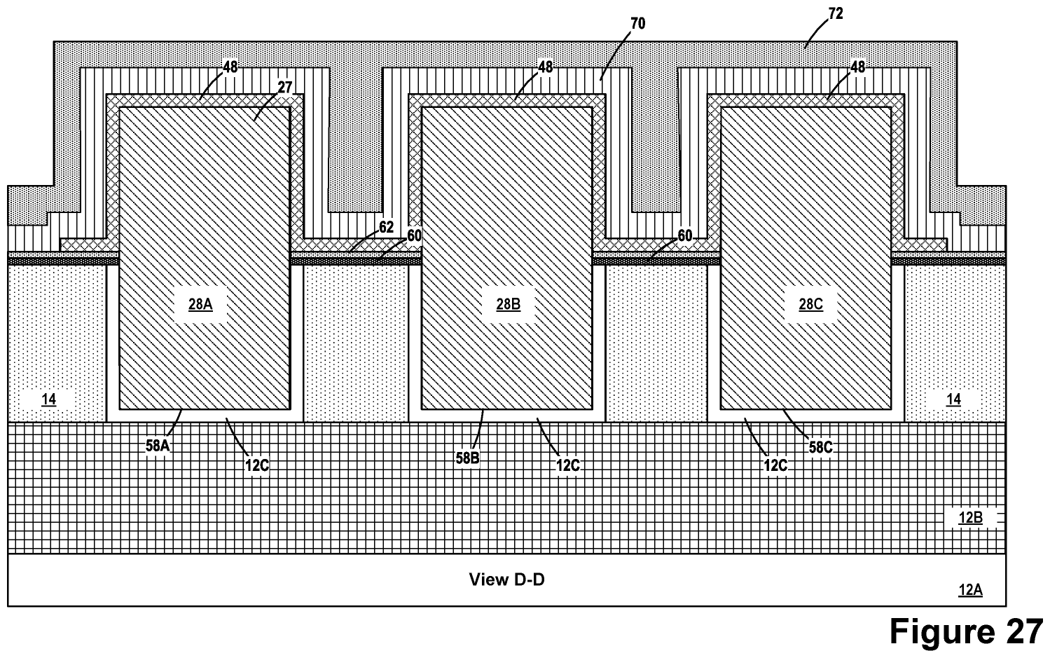

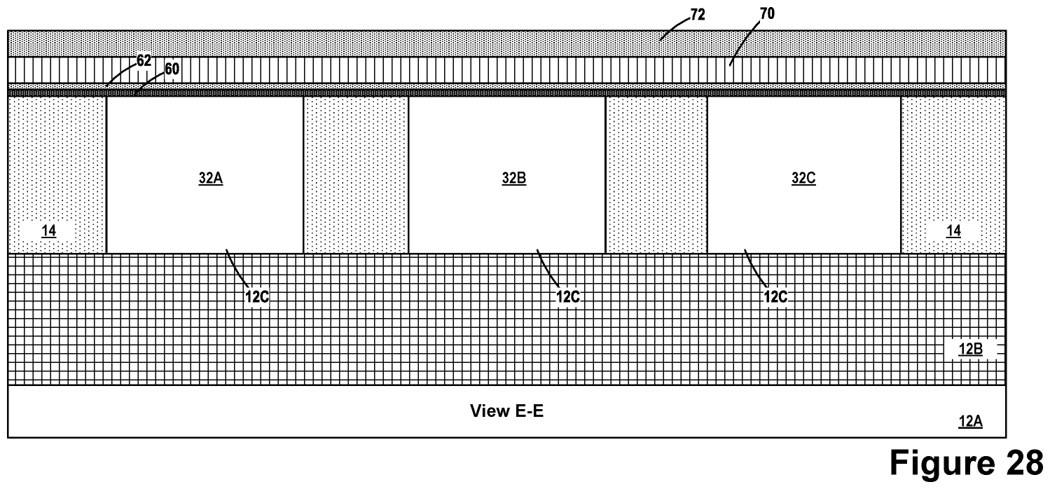

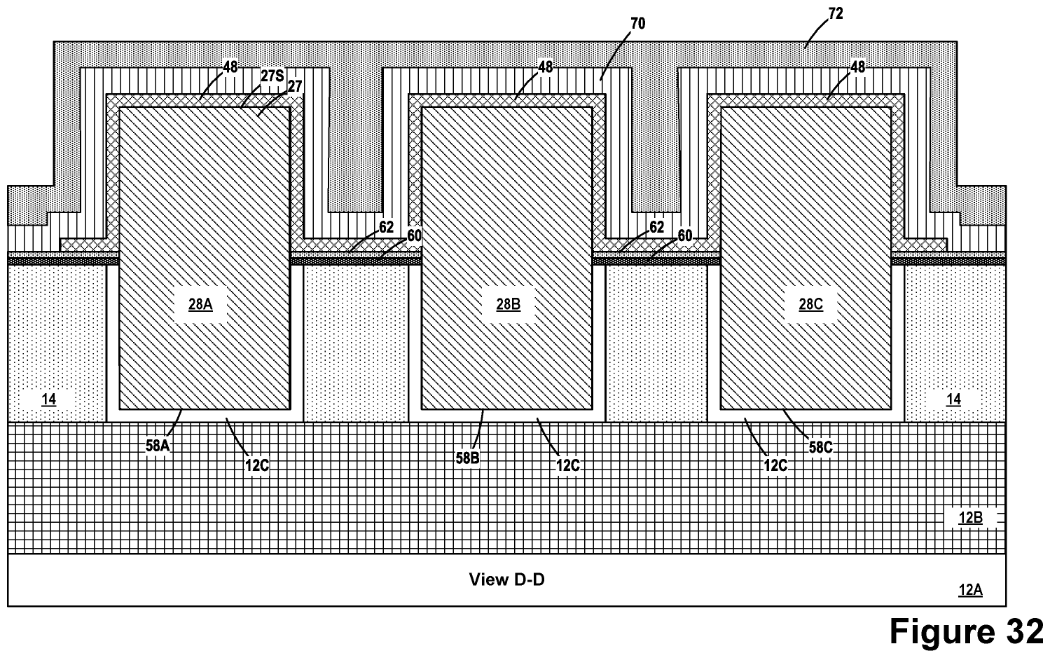

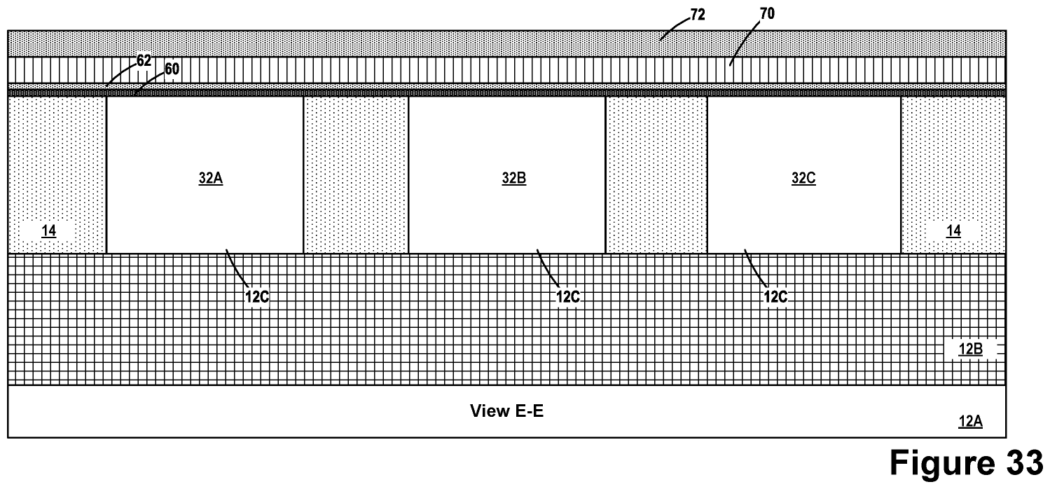

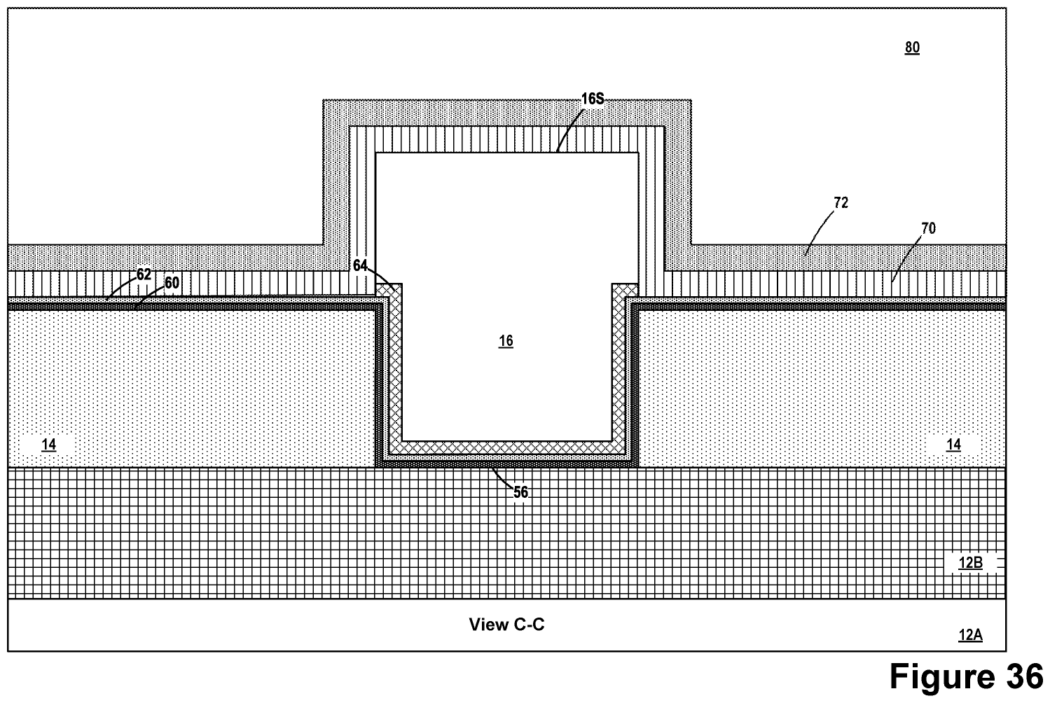

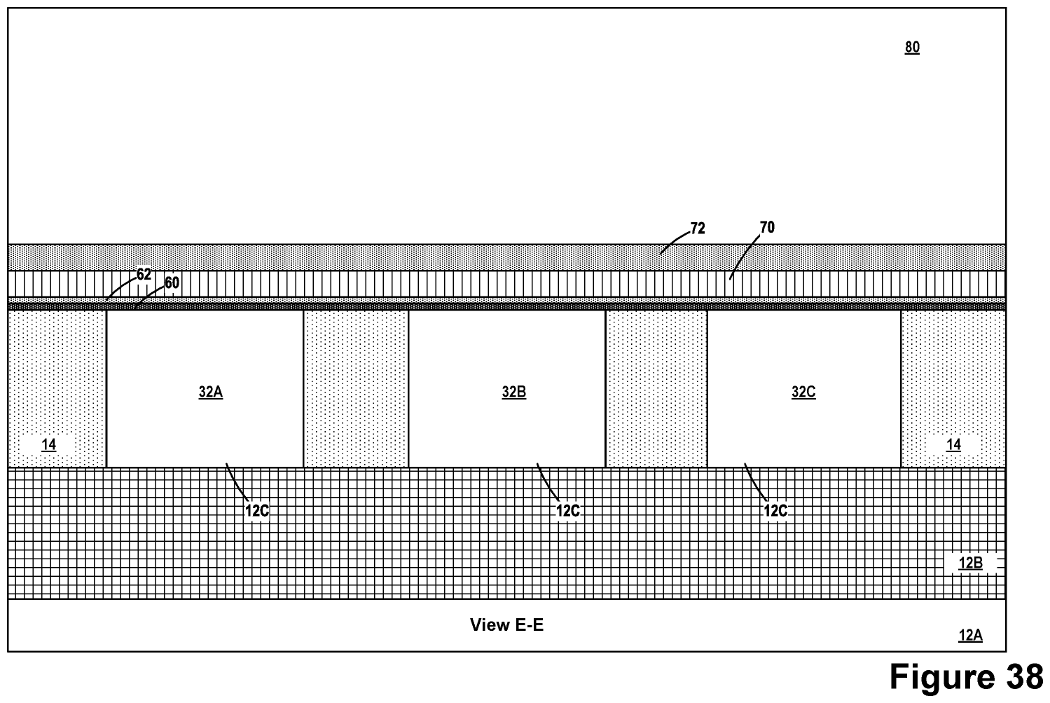

FIGS. 1-38 depict various novel embodiments of a device 10 comprising an optofluidic sensor with integrated photodiode and various novel methods of making such a device 10. FIG. 1 is a simplistic plan view and a partial sectional view of one illustrative embodiment of the device 10. The device 10 will be fabricated in and above a semiconductor substrate 12 (see FIG. 3). With reference to FIG. 1, in one illustrative embodiment, the device 10 generally comprises a first photodiode array 11, a second photodiode array 13, a waveguide array 15, a channel 16, an input fluid reservoir 18, an output fluid reservoir 20, a first radiation source 34 that is adapted to generate radiation 44 in a direction toward the channel 16, and a second radiation source 38 that is adapted to generate radiation 42 in a direction toward the channel 16. The channel 16 has a first side surface 16X and a second side surface 16Y that is opposite the first side surface 16X. The channel 16 is in fluid communication with the input fluid reservoir 18 and the output fluid reservoir 20, and the channel 16 is adapted to receive the fluid 22 therein. As will be appreciated by those skilled in the art after a complete reading of the present application, the optofluidic sensor with integrated photodiode disclosed herein will be used to analyze samples, e.g., DNA, virus, etc. (not shown), present in the fluid 22 as the samples flow through the channel 16 of the device 10.

In one illustrative embodiment, a plurality of fluid flow baffles 24A-D (generally referenced using the numeral 24) are formed within the channel 16 at a location between the first photodiode array 11 and the waveguide array 15. The flow baffles 24 are part of the channel 16 and they partially define a plurality of restricted flow paths 25A-C (generally referenced using the numeral 25). The flow paths 25 have an axial length 25L and when they are present, they are in fluid communication with the channel 16. As shown in FIG. 1, the fluid 22 splits into simplistically depicted fluid flow streams 22A-C. The size and flow area of each of the restricted flow paths 25 may be approximately the same, but that may not be the case in all applications. Similarly, the speed at which the samples pass through each of the fluid flow streams 22A-C may be different from one another, but that may not be the case in all applications. After passing through the restricted flow paths 25, the fluid flow streams 22A-C recombine and the samples in the fluid 22 flow into the output fluid reservoir 20. However, as will be appreciated by those skilled in the art after a complete reading of the present application, the flow baffles 24 (and the restricted flow paths 25) may not be present in some applications, e.g., the channel 16 may have a substantially constant cross-sectional fluid flow area throughout substantially the entire axial length of the channel 16. Also depicted in FIG. 1 is an isolation material 14, e.g., silicon dioxide. Other structures and features shown in FIG. 1 will be discussed later in the application.

As noted above, the optofluidic sensor with integrated photodiode disclosed herein will be used to analyze samples, e.g., DNA, virus, etc., in the fluid 22 as the samples move through the channel 16. That is, in one illustrative example, the device 10 will be used to measure the photon count of the fluorescence signal of the sample as excited by one or both of the radiation sources 34, 38, and compare that measured value to a reference value. Typically, during the process of analyzing the samples, the fluid 22 is held in an approximate steady state condition and the samples contained within the fluid 22 (DNA, virus, etc.) are moved from the input fluid reservoir 18 to the output fluid reservoir 20 using electrostatic forces by mechanisms that are known to those skilled in the art. Electrical contacts are made through the input fluid reservoir 18 and the output fluid reservoir 20. As the samples pass through the flow baffles 24, the samples elongate, which results in a longer interaction time of the radiation source with the sample, which results in an improved signal-to-noise ratio of the fluorescence signal to the background radiation noise floor as compared to prior art optofluidic sensors, thereby making the analysis of the samples more accurate as compared to prior art optofluidic sensors. In one illustrative embodiment, depending upon, among other things, the nature of the samples, the samples (not shown) may elongate by about 10-50% as the samples pass through the fluid flow paths 25 (if present).

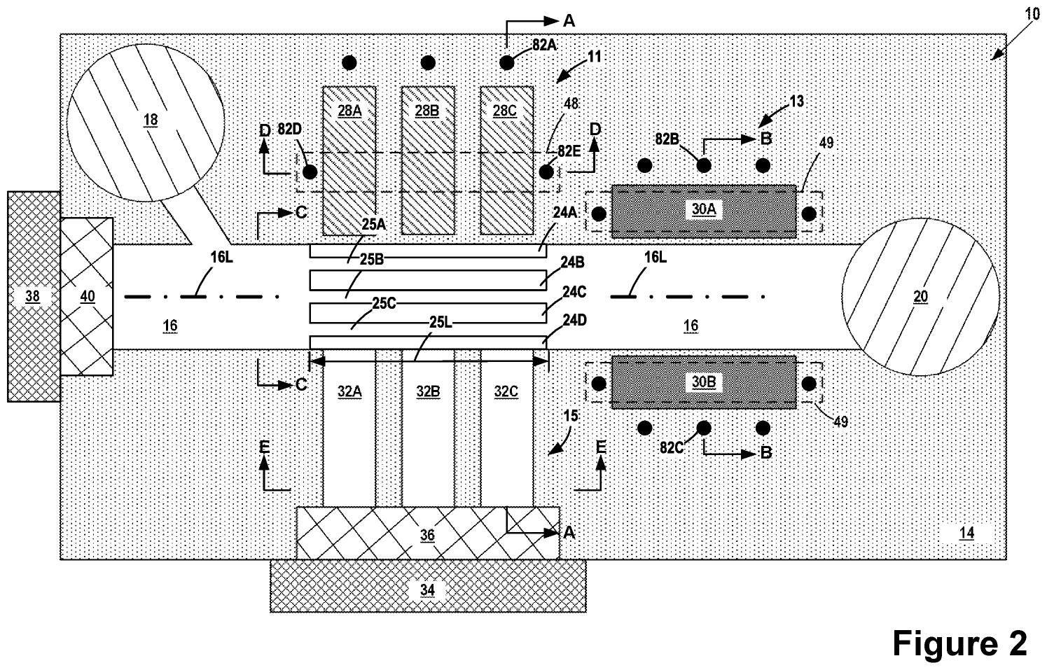

In the depicted example, the first photodiode array 11 comprises three illustrative doped photodiodes 28A-C (generally referenced using the numeral 28), e.g., PIN diodes. Of course, as will be appreciated by those skilled in the art after a complete reading of the present application, the device 10 may comprise any number of photodiodes 28, and, in some cases, the device 10 may comprise only a single diode 28. In some cases, the photodiodes 28 may be omitted entirely and the device may only comprise the second photodiode array 13. The photodiodes 28 may be of any physical size or configuration, and the size and configuration of each of the photodiodes 28 need not be the same, but that may be the case in some applications. The photodiodes 28 may be comprised of a variety of different materials, e.g., a doped semiconductor material, such as germanium, silicon, silicon-germanium, germanium-tin, a III-V material, etc. The techniques of forming such photodiodes 28 are well known to those skilled in the art. In the particular example depicted herein, the photodiodes 28 have a substantially rectangular configuration, wherein, when viewed from above, the long axis of the photodiodes 28 (extending from top to bottom in FIG. 1) is oriented substantially normal to the centerline 16L (see FIG. 2) of the channel 16. Of course, the photodiodes 28 could have a substantially square configuration when viewed from above, wherein one axis of the photodiodes 28 is oriented substantially normal to the centerline 16L. As will be appreciated by those skilled in the art after a complete reading of the present application, in this particular example of the device 10, the photodiodes 28 are adapted for sensing the orthogonal fluorescence of the samples in the fluid 22 flowing through the channel 16 when irradiated by the first and/or second radiation sources 34, 38 and, more specifically, the orthogonal fluorescence of the elongated samples in the fluid 22 flowing through the restricted flow paths 25 (if they are present on the device 10). Also depicted in FIG. 1 is a conductive structure 48 (e.g., a metal line, a metal silicide) that is conductively coupled to the photodiodes 28 and simplistically depicted conductive contacts 82 that are conductively coupled to the conductive structure 48. Other of the conductive structures 82 are conductively coupled to portions of the active layer of the semiconductor substrate 12, as described more fully below.

In the depicted example, the second photodiode array 13 comprises two illustrative doped photodiodes 30A-B (generally referenced using the numeral 30). Of course, as will be appreciated by those skilled in the art after a complete reading of the present application, the device 10 may comprise any number of photodiodes 30, and, in some cases, the device 10 may comprise only a single diode 30. However, in some applications, the photodiodes 30 may be omitted entirely. The photodiodes 30 may be of any physical size or configuration, and the size and configuration of each of the photodiodes 30 need not be the same, but that may be the case in some applications. The photodiodes 30 may be comprised of a variety of different materials, e.g., a doped semiconductor material, such as germanium, silicon, silicon-germanium, germanium-tin, a III-V material, etc. The techniques of forming such photodiodes 30 are well known to those skilled in the art. In the particular example, the photodiodes 30 have a substantially rectangular configuration, wherein, when viewed from above, the long axis of the photodiodes 30 (extending from left to right in FIG. 1) is oriented substantially parallel to the centerline 16L (see FIG. 2) of the channel 16. Of course, the photodiodes 30 could have a substantially square configuration when viewed from above, wherein one axis of the photodiodes 30 is oriented substantially parallel to the centerline 16L. As will be appreciated by those skilled in the art after a complete reading of the present application, the photodiodes 30 are adapted for sensing the fluorescence due to laser excitation parallel to the flow of the samples in the fluid 22 flowing through the channel 16. In the depicted example, where the second photodiode array 13 comprises a plurality of photodiodes 30, one of the photodiodes (e.g., 30A) may be positioned adjacent the second side 16Y of the channel, while another of the plurality of photodiodes (e.g., 30B) may be positioned adjacent the first side 16X of the channel 16 and opposite the photodiode 30A. In this particular example, the photodiodes 30 are positioned downstream (in terms of the direction of flow of the samples in the fluid 22), but that may not be the case in all applications. Moreover, in some applications, one of the first photodiode array 11 or the second photodiode array 13 may be omitted entirely. For example, in one particular embodiment, the first photodiode array 11 may be omitted and the second photo array 13 may be positioned adjacent the restricted flow paths 25. Also depicted in FIG. 1 is a conductive structure 49 (e.g., a metal line, a metal silicide) that is conductively coupled to each of the photodiodes 30 and simplistically depicted conductive contacts 82 that are conductively coupled to each of the conductive structures 49.

In the depicted example, the waveguide array 15 comprises three illustrative waveguide structures 32A-C (generally referenced using the numeral 32). Of course, as will be appreciated by those skilled in the art after a complete reading of the present application, the device 10 may comprise any number of waveguide structures 32, and, in some cases, the device 10 may comprise only a single waveguide structure 32. Each of the waveguide structures 32 is adapted to transmit radiation generated by the first radiation source 34 toward the channel 16. Each of the waveguide structures 32 are positioned between the first radiation source 34 and the first side 16X of the channel 16. The waveguide structures 32 are constructed to support guided modes of a particular wavelength. Waveguide dimensions are correlated to the wavelength of the laser excitation and the index of refraction of the waveguide core. The waveguide structure(s) 32 may be of any physical size or configuration, and the size and configuration of the waveguide structures 32 need not be the same, but that may be the case in some applications. The waveguide structures 32 may be comprised of a variety of different materials, e.g., a semiconductor material, such as silicon, silicon nitride, etc. The techniques of forming such waveguide structures 32 are well known to those skilled in the art. In the particular example depicted herein, the waveguide structures 32 have a substantially rectangular configuration, wherein, when viewed from above, the long axis of the waveguide structures 32 (extending from top to bottom in FIG. 1) of the waveguide structures 32 is oriented substantially normal to the centerline 16L (see FIG. 2) of the channel 16. Of course, the waveguide structures 32 could have a substantially square configuration when viewed from above, wherein one axis of the waveguide structures 32 is oriented substantially normal to the centerline 16L. As will be appreciated by those skilled in the art after a complete reading of the present application, the waveguide structures 32 are adapted to guide and/or direct radiation 44 generated by the first radiation source 34 toward the channel 16 and the samples in the fluid 22 therein. More specifically, in the depicted embodiment, the waveguide structures 32 are adapted to guide and/or direct radiation 44 generated by the first radiation source 34 toward the samples in the fluid 22 in the restricted flow paths 25 (if present) in the channel 16.

The first and second radiation sources 34, 38 may take a variety of forms. In one illustrative example, the first and second radiation sources 34, 38 may comprise optical fiber that is coupled to the device 10 by any of a variety of different simplistically depicted attachment mechanisms 36, 40, respectively, e.g., trenches in which the optical fibers are positioned and bonded. The first and second radiation sources 34, 38 may be adapted to generate radiation at any desired wavelength. In one illustrative embodiment, the first and second radiation sources 34, 38 may be adapted to generate radiation at wavelengths that fall within the range of 0.4-3.0 μm. In one illustrative embodiment, the first radiation source 34 is adapted to generate radiation 44 in a direction that is substantially normal to the centerline 16L of the channel 16 (e.g., substantially normal to the direction of the flow of the samples in the fluid 22) and thereby cause the irradiated samples to fluoresce. In one illustrative embodiment, the second radiation source 38 is adapted to generate radiation 42 in a direction that is substantially parallel to the centerline 16L of the channel 16 (e.g., substantially parallel to the direction of the flow of the samples in the fluid 22) and thereby cause the irradiated samples to fluoresce. In the particular example depicted herein, the first radiation source 34 is positioned on the first side 16X of the channel 16, while the photodiodes 28 are positioned adjacent the second opposite side 16Y of the channel 16.

The energy required to cause the movement of the samples in the fluid 22 from the input fluid reservoir 18 to the output fluid reservoir 20 may be provided by a variety of known systems and techniques, e.g., known pumping systems, known systems that employ capillary forces as the motive force for the fluid 22, known systems employing known electrophoretic forces, etc. The physical size of the input fluid reservoir 18 and the output fluid reservoir 20 may vary depending upon the particular application. The fluid 22 may be any type of liquid, e.g., buffer, pH buffer, Tris buffer, Tris EDTA buffer, etc. As noted above, in one illustrative embodiment, the fluid 22 may contain biological materials, e.g., DNA, a virus. In other applications, the fluid 22 may be substantially free of any particles or materials.

In the depicted example of the device 10, at least one waveguide 32 is positioned between the first radiation source 34 and the first side 16X of side channel 16 and at least one photodiode 28 is positioned adjacent the second side 16Y of the channel 16 and opposite the at least one waveguide 32. Additionally, when at least one of the flow paths 25 is formed in the device 10, at least a portion of the axial length 25L of the at least one fluid flow path 25 is positioned between the at least one waveguide 32 and the at least one photodiode 28.

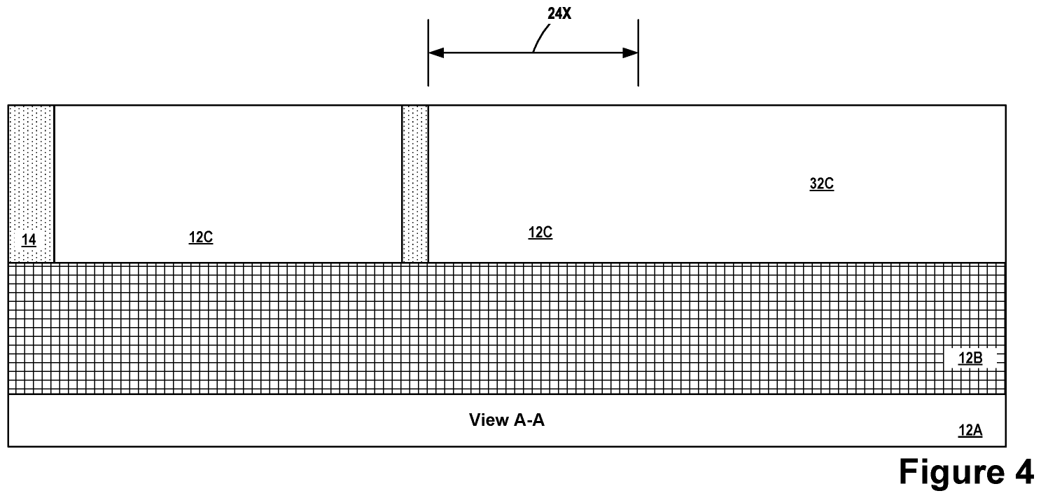

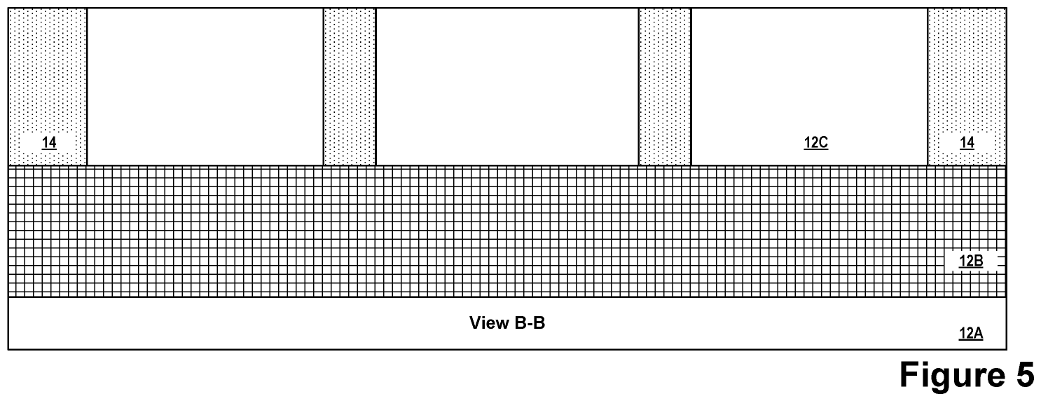

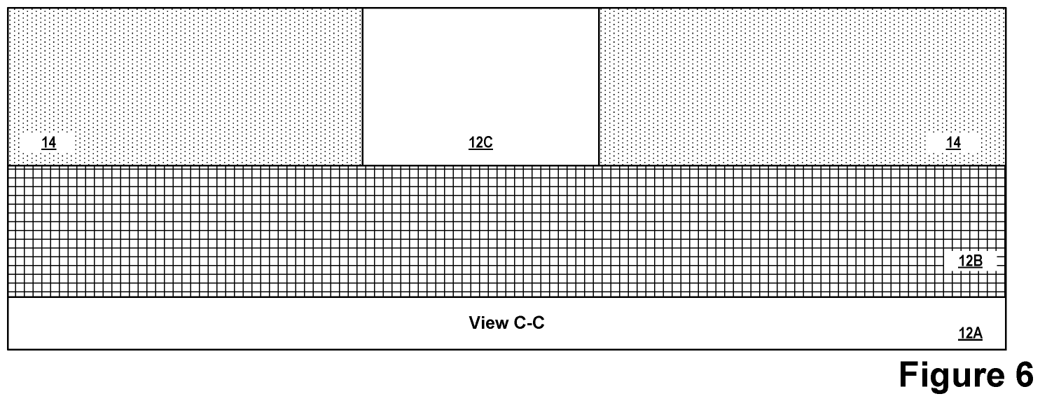

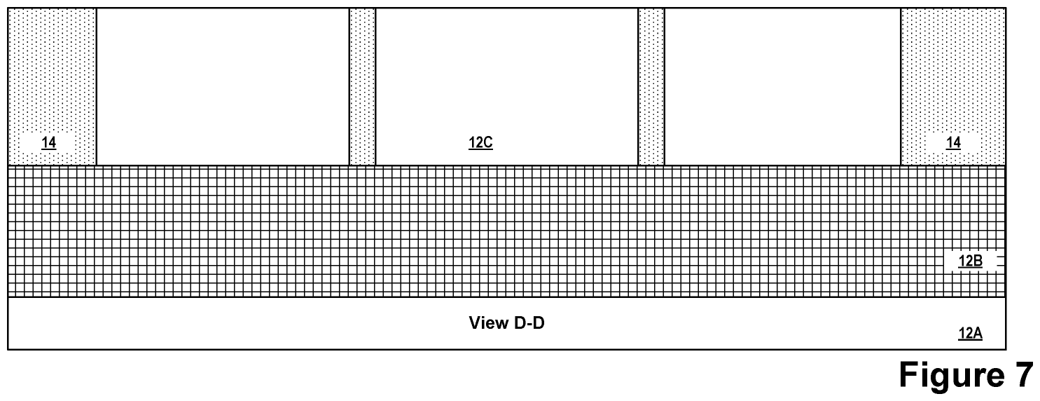

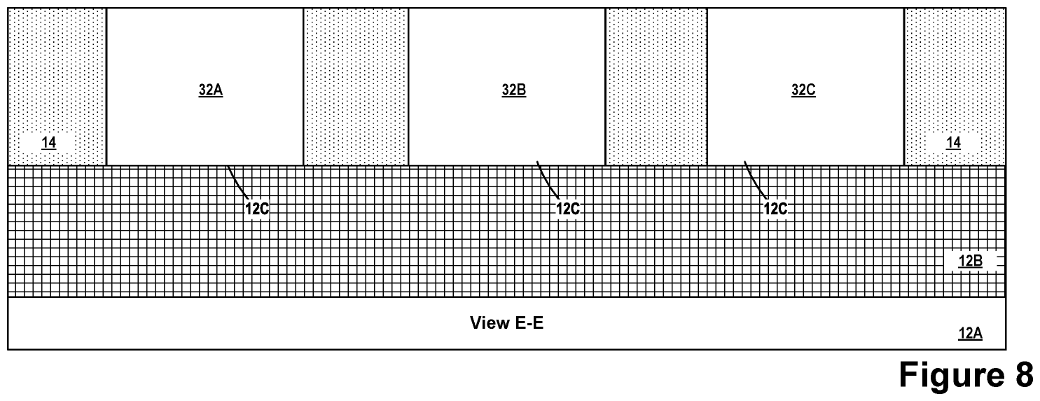

FIG. 2 is a copy of FIG. 1 with some of the reference numbers and fluid flow arrows omitted. The purpose of FIG. 2 is to show where various cross-sectional views shown in the attached drawings are shown. The view A-A is taken through the photodiode 28C, the channel 16, the flow baffles 24 and the photodiode 32C. The view A-A is shown in FIGS. 4, 9, 14, 19, 24, 29 and 34. The view B-B is taken through the photodiodes 30A-B and the channel 16. The view B-B is shown in FIGS. 5, 10, 15, 20, 25, 30 and 35. The view C-C is taken through the channel 16 in a direction transverse to the centerline 16L of the channel 16. The view C-C is shown in FIGS. 6, 11, 16, 21, 26, 31 and 36. The view D-D is taken through the photodiodes 28. The view D-D is shown in FIGS. 7, 12, 17, 22, 27, 32 and 37. The view E-E is taken through the waveguide structures 32. The view E-E is shown in FIGS. 8, 13, 18, 23, 28, 33 and 38. Some of the materials shown in the attached cross-sectional views are not depicted in FIG. 1 or 2 so as to not overly complicate the drawings.

With reference to FIG. 3, in the depicted example, the device 10 will be formed above a semiconductor substrate 12. The substrate 12 may have a variety of configurations, such as a semiconductor-on-insulator (SOI) shown herein. Such an SOI substrate 12 includes a base semiconductor layer 12A, a buried insulation layer 12B positioned on the base semiconductor layer 12A and an active semiconductor layer 12C positioned above the buried insulation layer 12B, wherein the device 10 will be formed in and above the active semiconductor layer 12C. The thickness of the active semiconductor layer 12C and the buried insulation layer 12B may vary depending upon the particular application, and it should be understood that the drawings depicted herein are not to scale. Typically, the base semiconductor layer 12A will be thicker than the active semiconductor layer 12C. In one illustrative embodiment, the active semiconductor layer 12C may be substantially free of any appreciable amount of dopant material, i.e., the active semiconductor layer 12C may be an intrinsic semiconductor material. The active semiconductor layer 12C and the base semiconductor layer 12A need not be made of the same semiconductor material, but that may be the case in some applications. In some applications, the active semiconductor layer 12C and the base semiconductor layer 12A may be made of silicon or they may be made of semiconductor materials other than silicon. Thus, the terms “substrate” or “semiconductor substrate” should be understood to cover all semiconductor materials and all forms of such materials. The buried insulation layer 12B may comprise any desired insulating material, e.g., silicon dioxide, silicon nitride, etc. As used herein and in the claims, the terms “substrate” or “semiconductor substrate” should be understood to mean the substrate as a whole. For example, in the case where the device 10 is formed on an SOI substrate, if it is stated that, for example, a flow path is at least partially defined in the substrate, it means the flow path can be at least partially defined by the active layer 12C alone, the buried insulation layer 12B alone or by the base semiconductor layer 12A alone or by any combination of the active layer 12C, the buried insulation layer 12B and the base semiconductor layer 12A. To the extent that it is necessary to distinguish between the active layer 12C, the buried insulation layer 12B or the base semiconductor layer 12A of an SOI substrate in the clams, those terms will be specifically used in the claims. Of course, if desired, the device 10 disclosed herein could be manufactured on a traditional bulk silicon substrate.

FIGS. 4-8 depict the device 10 after the active layer 12 was patterned (using known masking and etching techniques) and various isolation structures 14 were formed in the active layer 12C. In one illustrative process flow, after the active layer 12C was patterned and the etch mask was removed, an insulating material (e.g., silicon dioxide) was deposited so as to overfill the openings in the active layer 12C. Then a planarization process, such as a chemical mechanical planarization process, was performed to remove excess amount of the insulating material that are positioned outside of the openings in the active layer 12C and above the upper surface of the active layer 12C. In this particular example, the waveguide structures 32 will be made of the material of the active layer 12C. Thus, the formation of the isolation structures 14 results in the formation of the waveguide structures 32 (see FIG. 4 (waveguide 32C) and FIG. 8 (waveguides 32A-C)). With reference to FIG. 4, the flow baffles 24 will eventually be formed in the region 24X. In one illustrative embodiment, the flow baffles 24, and more specifically, the flow baffle 24D, will be formed in direct physical contact with the waveguides 32.

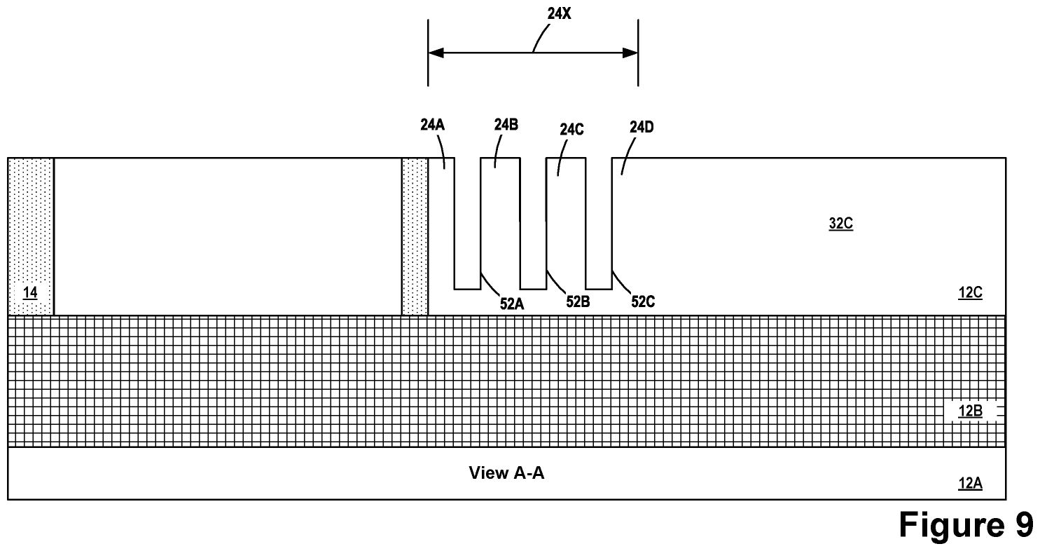

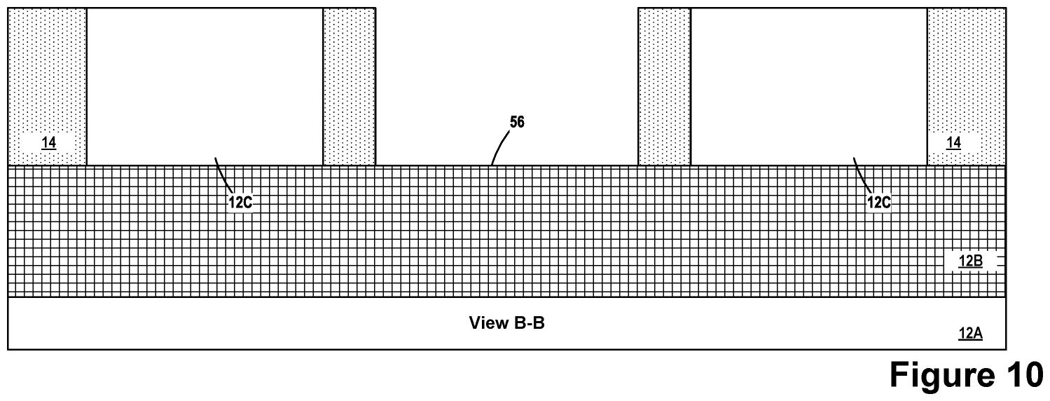

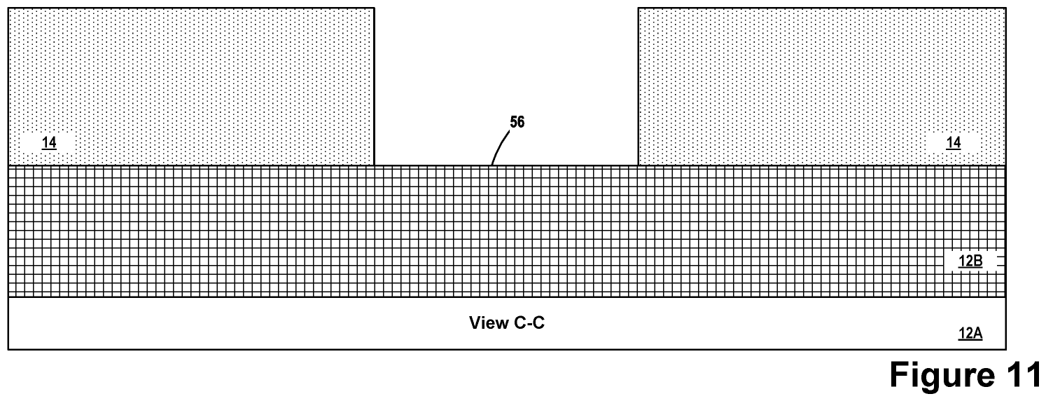

FIGS. 9-13 depict the device 10 after several process operations were performed. First, a first patterned etch mask (not shown) was formed above the device 10. Thereafter, an etching process was performed to remove exposed portions of the active layer 12C to thereby define trenches 56 for portions of the axial length of the channel 16 on opposite sides of the portion of the active layer 12C where the flow baffles 24 will be formed. See FIGS. 10 and 11. The flow baffles 24 have yet to be formed at this point in this illustrative process flow. In the case where the flow baffles 24 are omitted, a single trench 56 would be formed for the full axial length of the channel 16. Of course, as will be appreciated by those skilled in the art after a complete reading of the present application, there are a variety of different process flows that may be performed to form the novel device 10 disclosed herein. In the depicted example, the formation of the trenches 56 exposes the buried insulation layer 12B, i.e., the bottom of the trenches 56 is defined by the buried insulation layer 12B, but that may not be the case in all applications. The physical dimensions of the trenches 56 may vary depending upon the particular application. At that point, the first patterned etch mask may be removed.

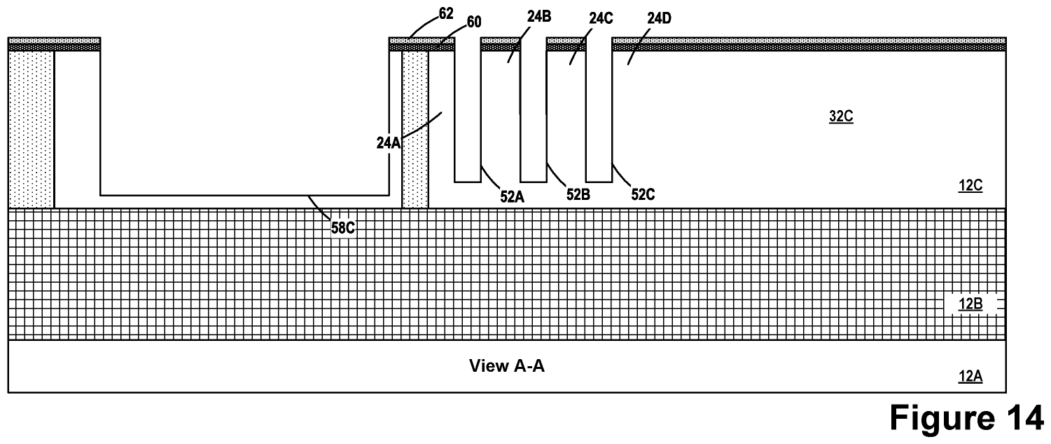

FIGS. 14-18 depict the device 10 after several process operations were performed. First, representative layers of material 60 and 62 were deposited on the device by performing multiple conformal deposition processes. As will be appreciated by those skilled in the art, the representative layers of material 60 and 62 will constitute a lower portion of an ARROW (Anti-Resonant Reflecting Optical Waveguide) structure for at least a portion of the axial length of the channel 16. In the case where the flow baffles 24 are omitted, the ARROW structure may extend for substantially the entire axial length of the channel 16. The function and structure of traditional ARROW structures are known to those skilled in the art. The representative layers of material 60 and 62 are representative in nature in that they represent multiple stacks of the layers, 60, 62. For example, in some applications, the device 10 may comprise three instances of such stacks or sets of the materials 60, 62 stacked on top of one another (i.e., a first layer 60 positioned on the active layer 12C, a first layer 62 positioned on the first layer 60; a second layer 60 positioned on the first layer 62, a second layer 62 positioned on the second layer 60; and a third layer 60 positioned on the second layer 62 and a third layer 62 positioned on the third layer 60). The number of such sets of the materials 60, 62 may vary depending upon a variety of factors, such as the optical loss specifications for the device 10. The layer of material 60 may be comprised of a variety of different materials, e.g., silicon dioxide, and it may be formed to any desired thickness, e.g., 100-1000 nm. The layer of material 62 may be comprised of a variety of different materials, e.g., silicon nitride, and it may be formed to any desired thickness, e.g., 100-1000 nm. Note that the layers of material 60 and 62 are formed prior to the formation of various epi semiconductor materials that will be formed on the device 10 (as described more fully below) and thus must be made of material that can withstand the relatively high temperature epi formation processes.

Still referencing FIGS. 14-18, the next process operation involves performing a conformal deposition process to form a layer of material 64 on the device 10. Then, a second patterned etch mask (not shown) was formed on the device 10. The second patterned etch mask covers the portions of the layer of material 64 positioned in the trenches 56. Thereafter, one or more etching processes were performed to remove exposed portions of the layer of material 64 relative to the surrounding materials. The layer of material 64 may be formed to any desired thickness and it may be comprised of a variety of different materials, e.g., polysilicon, amorphous silicon, etc. The layer of material 64 may be doped or undoped with a variety of materials. In one particular example, the layer of material 64 may be germanium-doped polysilicon. At that point, the second patterned etch mask may be removed.

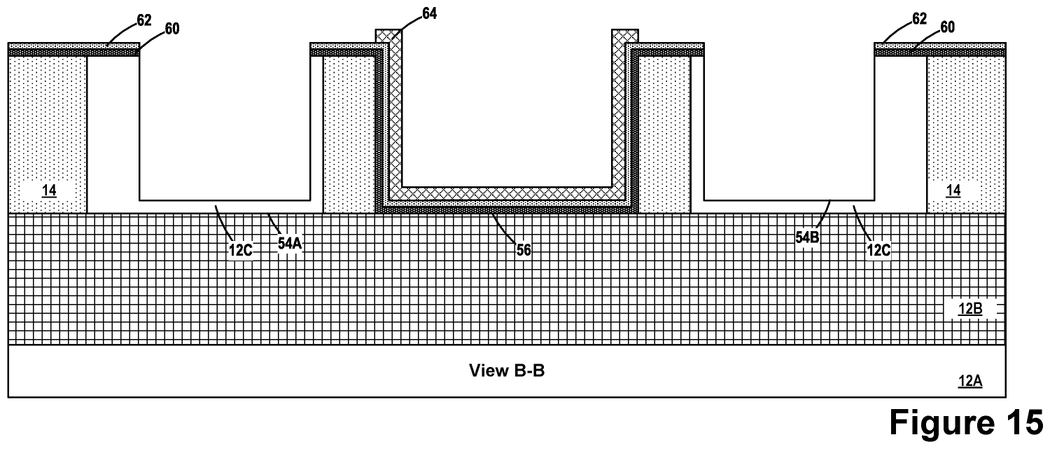

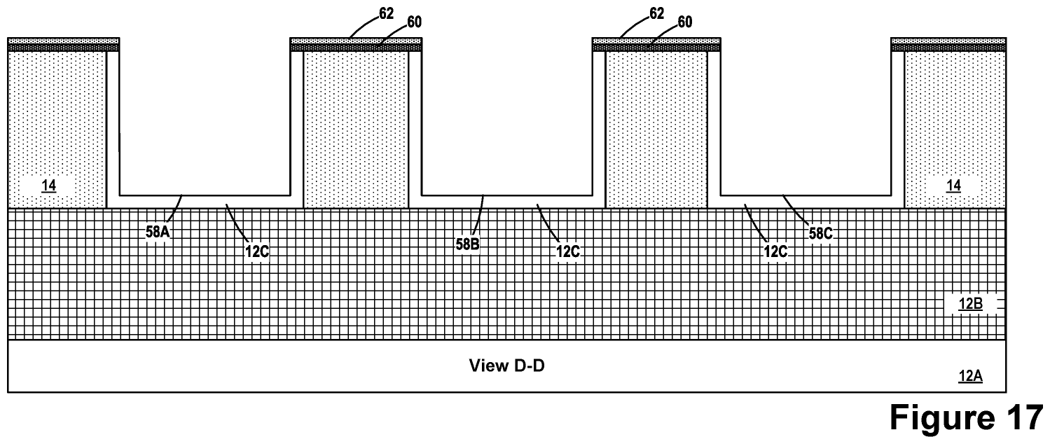

Thereafter, various masking and etching processes were performed to form various trenches in the active layer 12C and to remove exposed portions of the representative layers of material 60 and 62. As noted above, these trenches may be formed using a variety of different process flows. For example, in one illustrative example, a third patterned etch mask (not shown) was formed on the device 10. Thereafter, one or more etching processes were performed to remove exposed portions of the layers of material 60, 62 and, thereafter, exposed portions of the active layer 12C. In one particular example, these operations result in the formation of the trenches 54A and 54B (see FIG. 15—generally referenced using the numeral 54) for the photodiodes 30A, 30B, respectively, and the formation of trenches 58A-C (see FIG. 17—generally referenced using the numeral 58) for the photodiodes 28A-C, respectively. Note that, in this particular example, the trenches 54 and 58 do not extend for the full depth of the active layer 12C. The magnitude of the residual thickness of the active layer 12C at the bottom of the trenches 54 and 58 may vary depending upon the particular application. Also note that, in this example, the trenches 54 and 58 are formed so as to have substantially the same depth, but that may not be the case in all applications. At that point, the third patterned etch mask may be removed.

Still referencing FIGS. 14-18, a fourth patterned etch mask (not shown) was formed on the device 10. Thereafter, one or more etching processes were performed to remove exposed portions of the layers of material 60, 62 and, thereafter, exposed portions of the active layer 12C. In one particular example, these operations result in the formation of a plurality of trenches 52A-C (generally referenced using the numeral 52) in the active layer 12C and the flow baffles 24A-D. See FIG. 14. As will be described more fully below, the trenches 52A-C will become part of the restricted flow paths 25A-C, respectively, for the device 10. More specifically, the trenches 52 are at least partially defined by the substrate 12, e.g., the active layer 12C in the depicted example. Note that, in this particular example, the trenches 52 do not extend for the full depth of the active layer 12C. The magnitude of the residual thickness of the active layer 12C at the bottom of the trenches 52 may vary depending upon the particular application. Also note that, in this example, the depth of the trenches 52 may be less than, greater than or substantially equal to the depth of the trenches 54 and/or the trenches 58. At that point, the fourth patterned etch mask may be removed. Of course, the physical size, i.e., height, width, and length, of all of the trenches described in this patent application may vary depending upon the particular application.

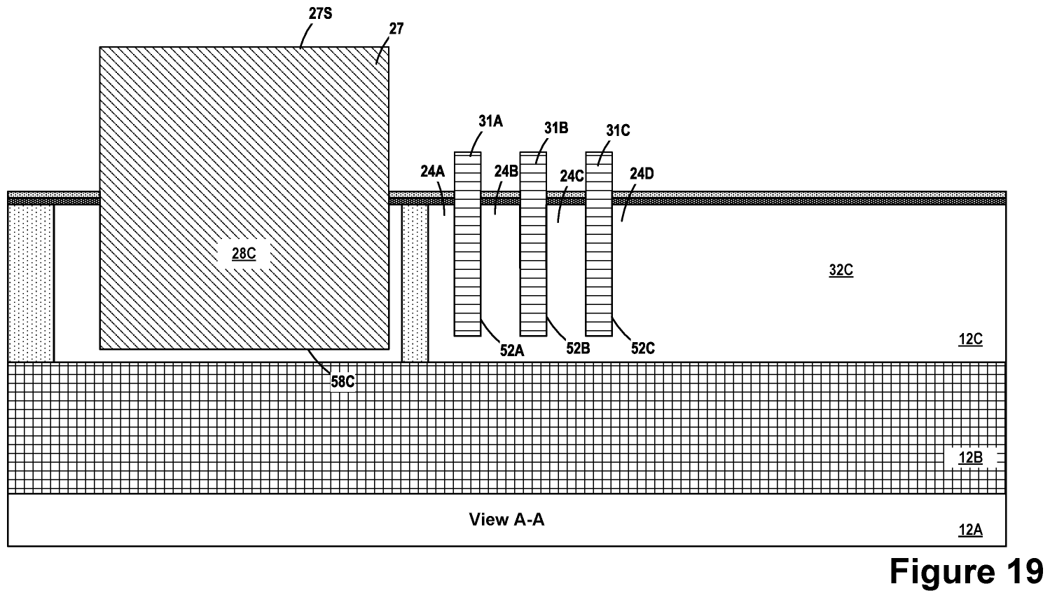

FIGS. 19-23 depict the device 10 after several process operations were performed. First, multiple regions of epitaxial semiconductor material in the various regions of the device 10 were formed by performing known epitaxial semiconductor growth processes. The regions of epitaxial semiconductor material may be formed in an undoped condition or at least some of them may be doped in situ. The regions of epitaxial semiconductor are shaded differently to facilitate explanation and such shading should not be interpreted that regions of epitaxial semiconductor material are made of different materials or that they are formed at different times in different processing steps, although that may be the case in some applications. In one illustrative process flow, all of the regions of epitaxial semiconductor material may be formed by performing a single epitaxial growth process. In other process flows, a patterned hard mask layer (not shown) may be formed on the device 10 to control the region where a particular epi semiconductor material is formed and thereafter removed. The patterned hard mask layer may then be removed, and the process repeated as needed to form additional epitaxial semiconductor material in a different region of the device 10.

As indicated in FIGS. 19-23, single crystal epi semiconductor material 27 for the photodiodes 28 has been formed in the trenches 58, single crystal epi semiconductor material 29 has been formed in the trenches 54 for the photodiodes 30, and single crystal epitaxial semiconductor material 31A-C (generally referenced using the numeral 31) has been formed in the trenches 52A-C, respectively. The single crystal epi materials 27, 29 and 31 are single crystal materials because the epi material was grown on the single crystal material of the active layer 12C. Also depicted in these drawings is a non-single crystal epi semiconductor material 33 (e.g., polycrystalline material) that was formed on the layer of material 64 in the trenches 56. The non-single crystal epi semiconductor material 33 has this structure because it was formed on the non-single crystal material of the layer of material 64. In one illustrative embodiment, the single crystal epi semiconductor material 27 for the photodiodes 28 and the non-single crystal epi semiconductor material 33 were formed in such a manner that the upper surface 27S of the epi material 27 is substantially co-planar with the upper surface 33S of the non-single crystal epi material 33. As is customary, at some point after the formation of the single crystal epi semiconductor materials 27, 29 for the photodiodes 28 and 30, known ion implantation techniques may be performed to form various doped regions in portions of the active layer 12C positioned adjacent the epi semiconductor materials 27, 29 for the photodiodes 28 and 30 and/or in the epi materials 27, 29.

The single crystal epi materials 27, 29 and 31 may be formed from a variety of different materials, e.g., germanium (Ge), silicon germanium (SiGe), silicon (Si), silicon-carbide (SiC), etc. The semiconductor materials for the single crystal epi semiconductor materials 27, 29 and 31 need not be made of the same material, but that may be the case in some applications. As described more fully below, the single crystal epi semiconductor material 31 should be made of a material that may be selectively removed (by etching) relative to the semiconductor material of the active layer 12C. The single crystal epi semiconductor materials 27 and 29 for the photodiodes 28, 30, need not be made of the same epitaxial semiconductor material, but that may be the case in some applications. As depicted, the single crystal epi semiconductor materials 27, 29 and 31 and the non-single crystal epi material 33 need not all have the same vertical thickness, but that may be the case in some applications. In one particular example, the single crystal epi semiconductor material 27 for the photodiodes 28 may comprise silicon-germanium, the single crystal epi semiconductor material 29 for the photodiodes 30 may comprise silicon-germanium, the single crystal epitaxial semiconductor material 27 may comprise germanium and the non-single crystal epi semiconductor material 33 may comprise germanium.

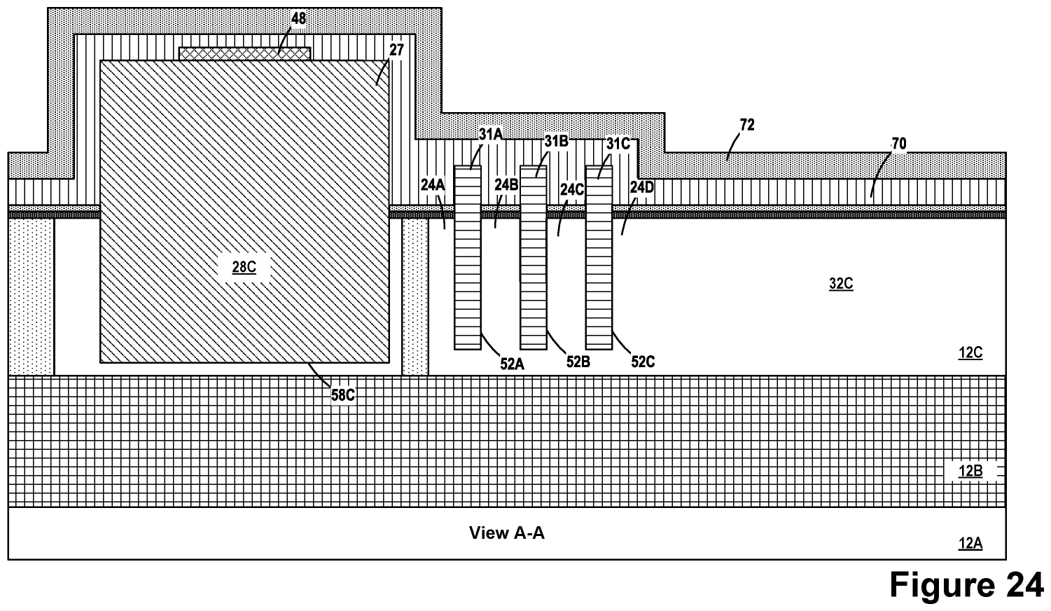

FIGS. 24-28 depict the device 10 after several process operations were performed. First, the conductive structure 48 was formed on the photodiodes 28 and the conductive structures 49 were formed on the photodiodes 30. The conductive structures 48, 49 may be formed of any conductive material and they may be formed by performing known manufacturing techniques.

Thereafter, representative layers of material 70 and 72 were deposited on the device 10 by performing conformal deposition processes. As will be appreciated by those skilled in the art, the representative layers of material 70 and 72 will constitute an upper portion of an ARROW (Anti-Resonant Reflecting Optical Waveguide) structure. The upper portion (the layers 70, 72) of the ARROW structure are positioned above the lower portion (the layers 60, 62) of the ARROW structure. In the illustrative example depicted herein, the upper portion of the ARROW structure extends for substantially the entire axial length of the channel 16. In one example where the device 10 comprises the flow paths 25, and following one illustrative process flow, the lower portion (the layers 60, 62) of the ARROW structure is not present on the bottom or sidewalls of the trenches 52 that at least partially define the flow paths 25, as described more fully below. Of course, if desired, a different process flow could be performed to form the layers of material 60, 62 in the trenches 52. In the case where the device 10 does not include the flow paths 25, the lower portion (the layers 60, 62) of the ARROW structure may extend for substantially the entire axial length of the channel 16.

Note that the layers of material 70 and 72 are formed after the formation of the above-described epi semiconductor materials. Accordingly, the layers of material 70 and 72 may be made of materials that do not have to withstand the relatively high temperature epi formation processes. As a result, the novel ARROW structure disclosed herein may comprise different materials (e.g., the materials 60, 62) for the lower portion of the ARROW structure as compared to the materials 70 and 72 for the upper portions of the ARROW structure. Such a configuration can be beneficial for forming more effective and efficient ARROW structures because it allows the use of additional materials for the upper portion of ARROW structure that may have different optical properties since the materials of the upper portion of the ARROW structure do not have to be materials capable of withstanding high temperature epi deposition processes. However, the materials 70, 72 must be deposited at temperatures that are less than the melting point of the previously formed epi semiconductor materials.

Still referencing FIGS. 24-28, representative layers of material 70 and 72 were deposited on the device 10 by performing multiple conformal deposition processes. The representative layers of material 70 and 72 are representative in nature in that they represent multiple stacks of the layers. For example, in some applications, the device 10 may comprise two instances of such stacks or sets of the materials 70 and 72 stacked on top of one another (i.e., a first layer 70 positioned on the uppermost layer 62, a first layer 72 positioned on the first layer 70, a second layer 70 positioned on the first layer 72 and a second layer 72 positioned on the second layer 70. The number of such sets of the materials 70 and 72 may vary depending upon a variety of factors, such as the optical loss specifications for the device 10. The layer of material 70 may be formed to any desired thickness, e.g., 10-1000 nm. The layer of material 70 may be comprised of a variety of different materials, e.g., a metal oxide, tantalum oxide, aluminum oxide, silicon nitride, etc. The layer of material 72 may be comprised of a variety of different materials, e.g., silicon dioxide, TiN, tantalum oxide, etc., and it may be formed to any desired thickness, e.g., 10-1000 nm.

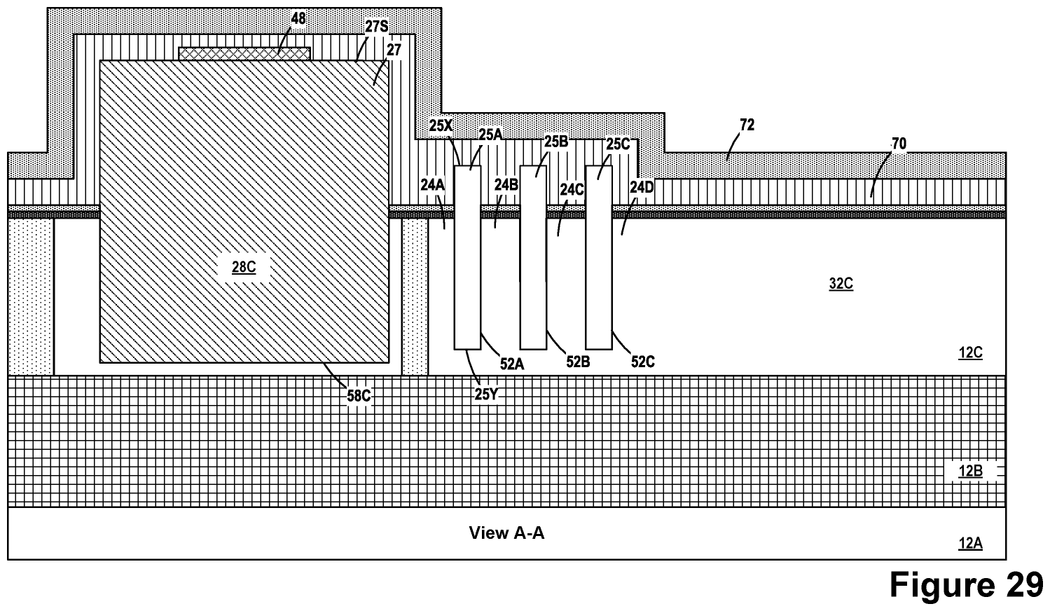

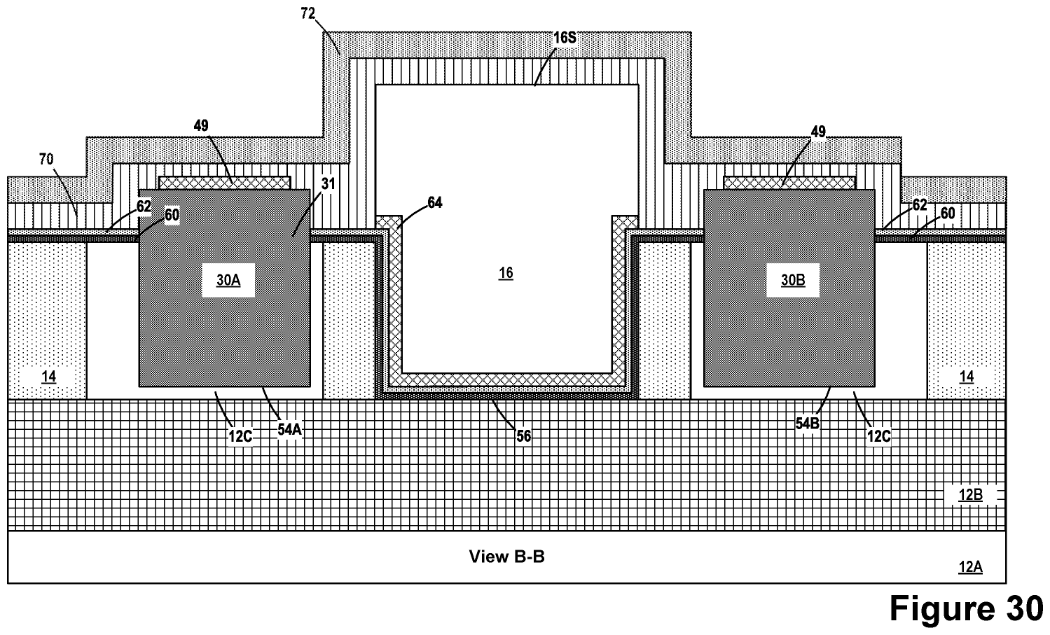

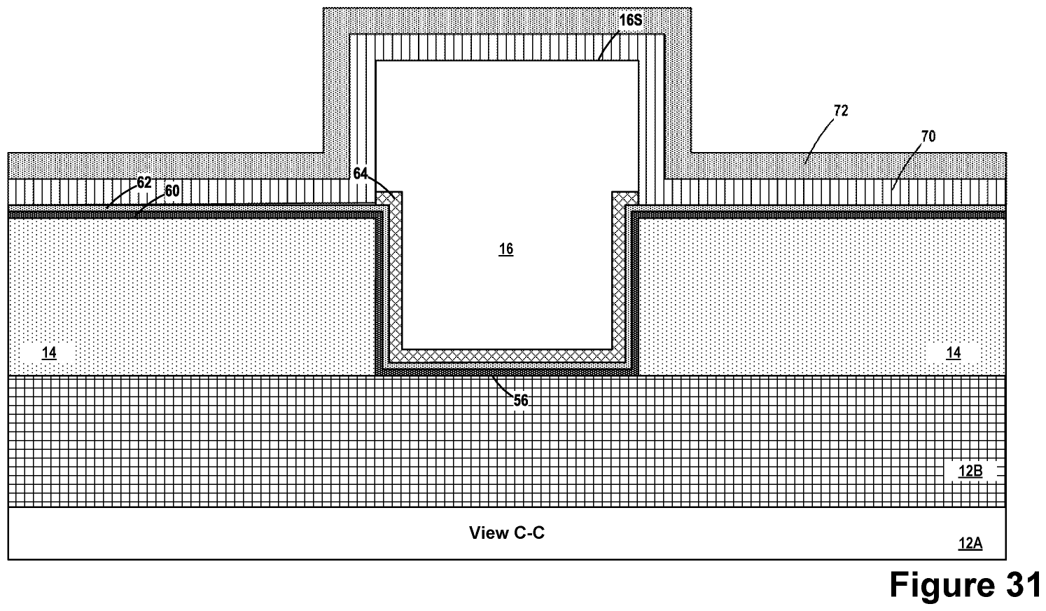

FIGS. 29-33 depict the device 10 after several process operations were performed. First, the non-single crystal semiconductor material 33 was removed selectively relative to surrounding materials by performing a wet etching process. This process operation forms portions of the channel 16 and exposes the epi semiconductor material 31 positioned in the trenches 52. Thereafter, in one illustrative process flow, another wet etching process was performed to remove the epi semiconductor material 31 relative to the surrounding materials. This process operation results in the formation of the restricted flow paths 25A-C that are in fluid communication with the portions of the channel 16 on opposite sides of the flow baffles 24, i.e., the portions of the channel 16 created by the removal of the non-single crystal semiconductor material 33. Note that, in the illustrative example depicted herein, the uppermost surface 16S of the channel 16 is positioned at a level that is substantially co-planar with the upper surface 27S of the single crystal epi semiconductor material 27 of the photodiodes 28. Also note that, in the illustrative example depicted herein, each of the restricted flow paths 25 is laterally bounded (in the left to right direction shown in the drawings) by a trench 52 formed in the active layer 12C, the layers of material 60, 62 and the layer of material 70. With reference to FIG. 29, the upper surface 25X and lower surface 25Y of each of the restricted flow paths 25 is bounded by the layer of material 70 and the active layer 12C, respectively. That is, the restricted flow paths 25 are partially defined by the substrate 12 and partially defined by the materials positioned above the active layer 12C. The dimensions of the restricted flow paths 25, i.e., the lateral width (left to right in FIG. 29), vertical height (top to bottom in FIG. 29) and the axial length (into and out of the plane of drawing page in FIG. 29) may all vary depending upon the particular application. Moreover, the physical dimension of all of the restricted flow paths 25 need not be the same, but that may be the case in some applications. In one illustrative example, the lateral width may fall within the range of about 2-500 nm, the vertical height may fall within the range of about 50 nm and the axial length of the restricted flow paths 25 may fall within the range of about 0.5-3 mm. With reference to FIGS. 30 and 31 and ignoring the ARROW structure, the channel 16 is at least partially defined in the substrate 12.

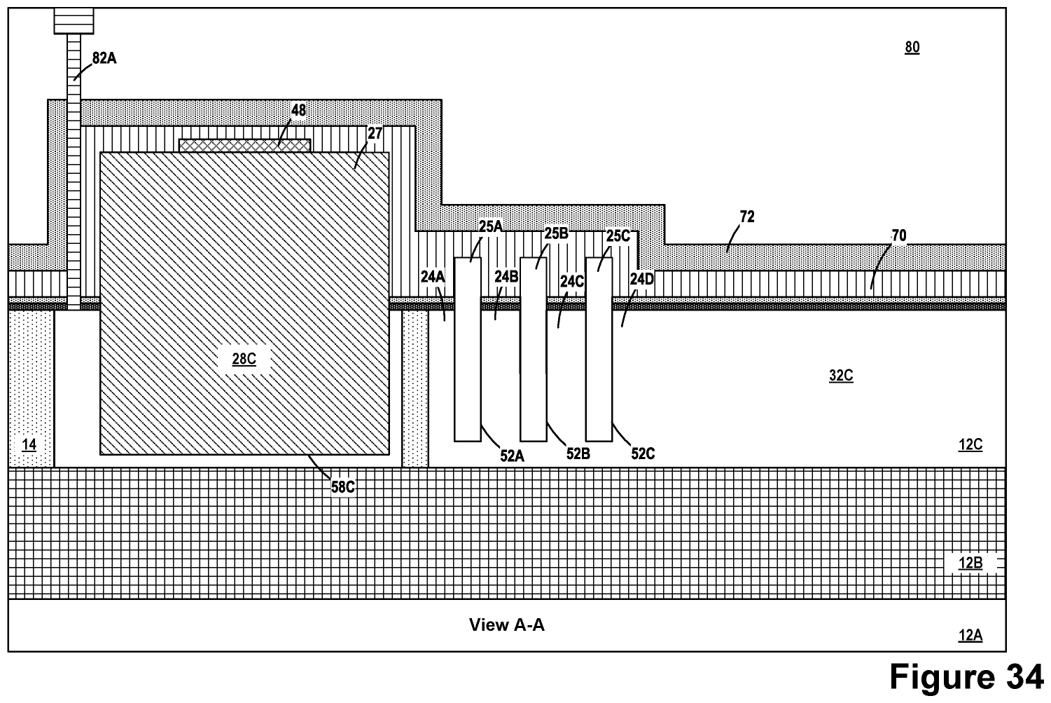

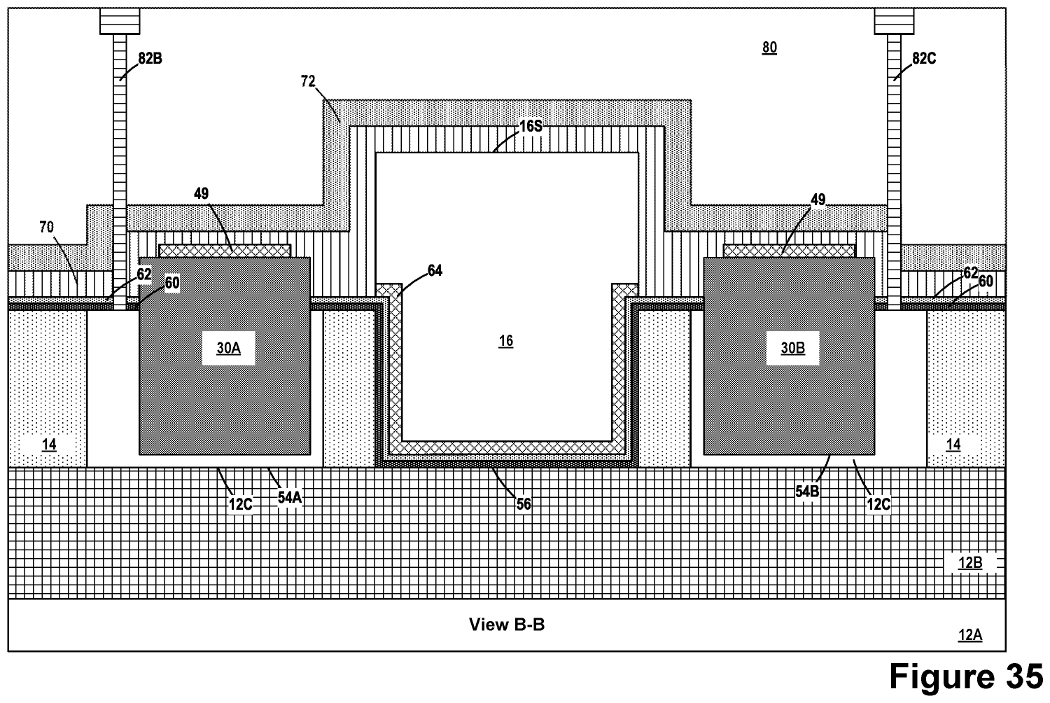

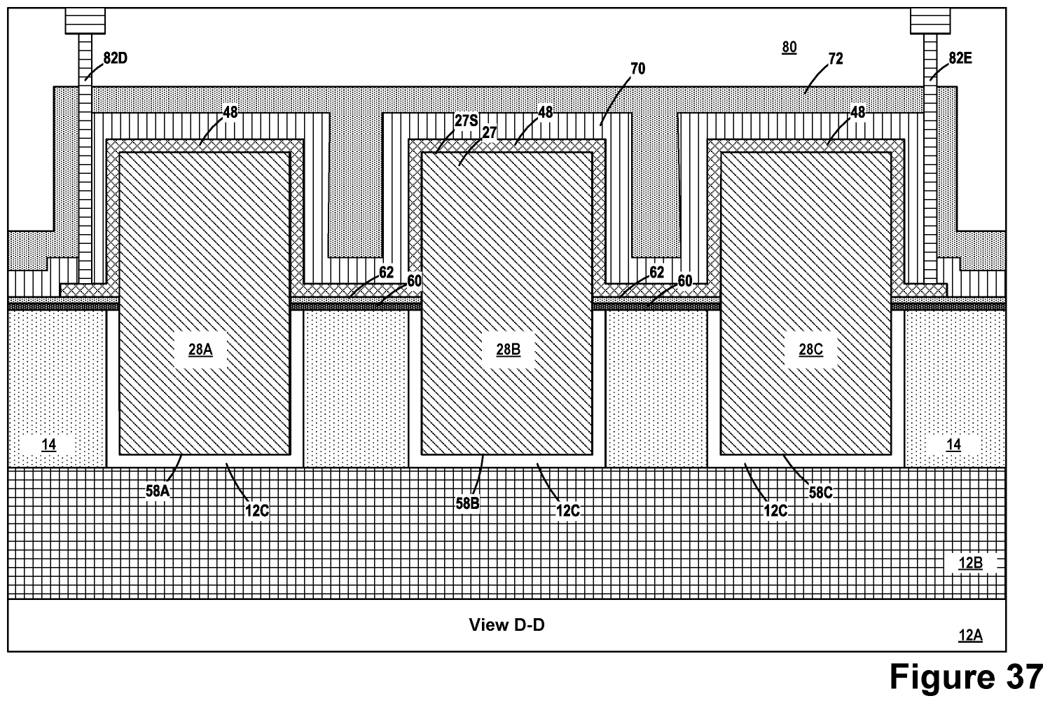

FIGS. 34-38 depict the device 10 after several process operations were performed. More specifically, at the point of processing in FIGS. 29-33, various traditional BEOL (Back End of Line) processing operations were performed to create a variety of BEOL structures. For example, a representative one or more layers of insulating material 80 were formed above the substrate 12. In a real-world device, the one or more layers of insulating material 80 may comprise multiple layers of material and the layers of material may be made of different materials. For example, the one or more layers of insulating material 80 may comprise one or more layers of silicon dioxide and/or a low-k material with a layer of silicon nitride (which functions as an etch stop layer) positioned between the layers of silicon dioxide and/or low-k material. The structure, composition and techniques used to form such layer(s) of insulating material 80 are well known to those skilled in the art. As noted above, various simplistically depicted conductive contacts 82 are formed to contact various structures on the device. For example, FIG. 34 depicts one of the conductive contacts 82 (i.e., 82A) that are conductively coupled to the doped active region 12C adjacent the photodiodes 28. FIG. 35 depicts one of the conductive contacts 82 (i.e., 82B) that are conductively coupled to the doped active region 12C adjacent the photodiode 30A as well as one of the conductive contacts 82 (i.e., 82C) that are conductively coupled to the doped active region 12C adjacent the photodiode 30B. FIG. 37 depicts the conductive contacts 82 (i.e., 82D, 82E) that are conductively coupled to the conductive structure 48. The simplistically depicted conductive contacts 82 may come in a variety of forms and configurations, they may be comprised of a variety of different conductive materials and they may be manufactured by performing known manufacturing techniques.

Various operational aspects to the illustrative and novel device 10 will now be described. For example, the first radiation source 34 is adapted to irradiate the samples in the fluid 22 by generating the radiation 44 that is directed in a direction that is substantially normal to the direction of the flow of the samples in the fluid in the channel 16 and more specifically in the restricted flow paths 25 (when present) so as to cause what can be referred to as the orthogonal fluorescence of the irradiated samples in the fluid 22. In addition, the second radiation source 38 is adapted to irradiate the samples in the fluid 22 by generating the radiation 42 that is directed in a direction that is substantially parallel to the direction of the flow of fluid 22 in the channel 16 and in the restricted flow paths 25 so as to cause what can be referred to as the fluorescence due to laser excitation parallel to the flow of the irradiated samples in the fluid 22. In turn, the photodiodes 28 are adapted for sensing the orthogonal fluorescence of the samples in the fluid 22 flowing through channel 16 and/or the restricted flow paths 25, while the photodiodes 30 are adapted to sense the parallel fluorescence of the samples in the fluid 22 flowing through the channel 16. By providing fluorescence excited in orthogonal directions in a two-dimensional plane, the identification of the target samples is better correlated to the multi-dimensional shape of the samples, e.g., DNA, virus, etc.

As will be appreciated by those skilled in the art after a complete reading of the present application, the device 10 disclosed herein includes several novel configurations. In no particular order of importance, the device 10 includes an optofluidic fluidic sensor incorporated with or integrated with at least one photodetector (28 or 30), all of which are formed on or above a single semiconductor substrate 12. In one particular embodiment, the device 10 also comprises a plurality of flow baffles 24 positioned within the channel 16 that at least partially define a plurality of restricted flow paths 25. As noted above, the novel ARROW structure disclosed herein may comprise different materials (e.g., the materials 60, 62) for the lower portion of the ARROW structure as compared to the materials 70 and 72 for the upper portions of the ARROW structure. Moreover, with reference to FIGS. 2 and 29, the lower portion of the ARROW structure (e.g., the materials 60, 62) are not formed within the restricted flow paths 25 for the axial length 25L (see FIG. 2) of the flow paths 25. Additionally, the restricted flow paths 25 are positioned between and separate the larger channels 16 on opposite sides of the flow baffles 24. As noted above, in one illustrative embodiment, the waveguides 32 are in direct physical contact with the flow baffles 24.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Note that the use of terms, such as “first,” “second,” “third” or “fourth” to describe various processes or structures in this specification and in the attached claims is only used as a shorthand reference to such steps/structures and does not necessarily imply that such steps/structures are performed/formed in that ordered sequence. Of course, depending upon the exact claim language, an ordered sequence of such processes may or may not be required. Accordingly, the protection sought herein is as set forth in the claims below.

1. A device, comprising:
a semiconductor substrate;
a channel that is adapted to receive a fluid therein, said channel being at least partially defined by at least a portion of said semiconductor substrate;
an input fluid reservoir;
an output fluid reservoir, wherein said channel is in fluid communication with said input fluid reservoir and said output fluid reservoir;
a first radiation source operatively coupled to said substrate, wherein said first radiation source is adapted to generate radiation in a direction toward said channel; and
at least one photodiode positioned adjacent said channel.

2. The device of claim 1, further comprising at least one flow baffle positioned within said channel, said at least one flow baffle partially defining at least one fluid flow path that is in fluid communication with said channel, said at least one fluid flow path being at least partially defined by at least a portion of said semiconductor substrate.

3. The device of claim 1, further comprising at least one waveguide positioned between said first radiation source and said channel, wherein said first radiation source is adapted to generate radiation in a direction that is substantially normal to a long axis of said channel, wherein said at least one waveguide is adapted to transmit radiation from said first radiation source toward said channel.

4. The device of claim 3, wherein said at least one waveguide comprises a plurality of waveguides, each of which comprises a long axis, and wherein, when viewed from above, said long axis of each of said plurality of waveguides is oriented substantially normal to said long axis of said channel and wherein each of said plurality of waveguides is adapted to transmit radiation from said first radiation source toward said channel.

5. The device of claim 1, wherein said first radiation source is adapted to generate radiation in a direction that is substantially parallel to a long axis of said channel.

6. The device of claim 1, further comprising a second radiation source, wherein said first radiation source is adapted to generate radiation in a direction that is substantially normal to a long axis of said channel and wherein said second radiation source is adapted to generate radiation in a direction that is substantially parallel to said long axis of said channel.

7. The device of claim 1, wherein said at least one photodiode comprises, when viewed from above, a long axis that is oriented substantially normal to a long axis of said channel.

8. The device of claim 7, wherein said at least one photodiode comprises a plurality of photodiodes, each of which comprises a long axis, wherein, when viewed from above, said long axis of each of said plurality of photodiodes is oriented substantially normal to said long axis of said channel.

9. The device of claim 1, wherein said first radiation source is positioned adjacent a first side of said channel and said at least one photodiode is positioned adjacent a second side of said channel that is opposite to said first side of said channel.

10. The device of claim 1, wherein said at least one photodiode comprises, when viewed from above, an axis that is oriented substantially parallel to a long axis of said channel.

11. The device of claim 10, wherein said at least one photodiode comprises a plurality of photodiodes, each of which comprises a long axis, wherein, when viewed from above, said long axis of each of said plurality of photodiodes is oriented substantially parallel to said long axis of said channel.

12. The device of claim 11, wherein at least one of said plurality of photodiodes is positioned on a first side of said channel and another of said plurality of photodiodes is positioned on a second side of said channel that is opposite to said first side of said channel.

13. The device of claim 1, further comprising an ARROW (Anti-Resonant Reflecting Optical Waveguide) structure positioned in at least a portion of an axial length of said channel, said ARROW structure comprising a lower portion and an upper portion positioned above said lower portion, wherein said lower portion and said upper portion are made of different materials.

14. The device of claim 1, wherein said semiconductor substrate is a semiconductor-on-insulator (SOI) substrate that comprises a base semiconductor layer, a buried insulation layer positioned on said base semiconductor layer and an active semiconductor layer positioned on said buried insulation layer, and wherein the device further comprises:
a trench in said semiconductor substrate that partially defines said channel, said trench having an axial length and a bottom surface defined by said buried insulation layer; and
an ARROW (Anti-Resonant Reflecting Optical Waveguide) structure, said ARROW structure comprising a lower portion and an upper portion positioned above said lower portion, wherein said lower portion of said ARROW structure is positioned in at least a portion of said axial length of said trench and on and in physical contact with said bottom surface of said trench.

15. A device, comprising:
a semiconductor substrate;
a channel that is adapted to receive a fluid therein, said channel being at least partially defined by at least a portion of said semiconductor substrate, said channel having a long axis and first and second opposing sides;
an input fluid reservoir;
an output fluid reservoir, wherein said channel is in fluid communication with said input fluid reservoir and said output fluid reservoir;
a first radiation source operatively coupled to said substrate, wherein said first radiation source is adapted to generate radiation in a direction that is substantially normal to said long axis of said channel;
at least one waveguide positioned between said first radiation source and said first side of said channel, wherein said at least one waveguide is adapted to transmit radiation from said first radiation source toward said channel;
at least one first photodiode positioned adjacent said second side of said channel and opposite to said at least one waveguide; and
at least one flow baffle positioned within said channel, said at least one flow baffle partially defining at least one fluid flow path that is in fluid communication with said channel, said at least one fluid flow path having an axial length wherein at least a portion of said axial length of said at least one fluid flow path is positioned between said at least one waveguide and said at least one first photodiode.

16. The device of claim 15, further comprising:
a second radiation source operatively coupled to said substrate, wherein said second radiation source is adapted to generate radiation in a direction that is substantially parallel to said long axis of said channel; and
at least one second photodiode positioned adjacent said channel.

17. The device of claim 15, wherein:
said at least one waveguide comprises a plurality of waveguides that constitute a waveguide array positioned between said first radiation source and said first side of said channel, each of said plurality of waveguides comprising a long axis, wherein, when viewed from above, said long axis of each of said plurality of waveguides is oriented substantially normal to said long axis of said channel and wherein each of said plurality of waveguides is adapted to transmit radiation from said first radiation source toward said channel;
said at least one first photodiode comprises a plurality of first photodiodes that constitute a first photodetector array, each of said plurality of first photodiodes comprising a long axis, wherein, when viewed from above, said long axis of each of said plurality of first photodiodes is oriented substantially normal to said long axis of said channel, and
said at least one flow baffle comprises a plurality of flow baffles that at least partially define a plurality of fluid flow paths that are in fluid communication with said channel, each of said plurality of fluid flow paths having an axial length, wherein at least a portion of said axial length of each of said plurality of fluid flow paths is positioned between said waveguide array and said first photodetector array.

18. The device of claim 15, further comprising an ARROW (Anti-Resonant Reflecting Optical Waveguide) structure positioned in at least a portion of an axial length of said channel, said ARROW structure comprising a lower portion and an upper portion positioned above said lower portion, wherein said lower portion and said upper portion are made of different materials.

19. A device, comprising:
a semiconductor substrate;
a channel that is adapted to receive a fluid therein, said channel being at least partially defined by at least a portion of said semiconductor substrate, said channel having a long axis and first and second opposing sides;
an input fluid reservoir;
an output fluid reservoir, wherein said channel is in fluid communication with said input fluid reservoir and said output fluid reservoir;
a first radiation source operatively coupled to said substrate, wherein said first radiation source is adapted to generate radiation in a direction that is substantially parallel to said long axis of said channel; and
at least one first photodiode positioned adjacent said channel.

20. The device of claim 19, wherein said at least one first photodiode comprises a plurality of first photodiodes, wherein one of said plurality of first photodiodes is positioned adjacent said first side of said channel and another of said plurality of first photodiodes is positioned adjacent said second side of said channel and wherein the device further comprises a second radiation source operatively coupled to said substrate, wherein said second radiation source is adapted to generate radiation in a direction that is substantially normal to said long axis of said channel.
